(19) United States
(12) Patent Application Publication
(10) Pub. No.: US 2023/0060461 A1
(43) Pub. Date: Mar. 2, 2023

(54) INFERENCE ENGINE CONFIGURED TO PROVIDE A HEAT MAP INTERFACE

(71) Applicant: Rakuten Symphony Singapore Pte. Ltd., Singapore (SG)

(72) Inventors: Krishnakumar KESAVAN, Mountain House, CA (US); Manish SUTHAR, San Mateo, CA (US)

(73) Assignee: Rakuten Symphony Singapore Pte. Ltd., Singapore (SG)

(21) Appl. No.: 17/581,228

(22) Filed: Jan. 21, 2022

Related U.S. Application Data
(60) Provisional application No. 63/234,333, filed on Aug. 18, 2021.

(51) Int. Cl. G06F 11/07; G06N 5/04

(52) U.S. Cl. CPC G06F 11/079; G06F 11/0709; G06N 5/04

(57) ABSTRACT

Server hardware failure is predicted, with a probability estimate, of a possible future server failure along with an estimated cause of the future server failure. Based on the prediction, the particular server can be evaluated and if the risk is confirmed, load balancing can be performed to move a load (e.g., virtual machines (VMs)) off of the at-risk server onto low-risk servers. High availability of deployed load (e.g., VMs) is then achieved. A flow of big data may be on the order of 1,000,000 parameters per minute. A scalable tree-based AI inference engine processes the flow. One or more leading indicators are identified (including server parameters and statistic types) which reliably predict hardware failure. This allows a telco operator to monitor cloud-based VMs and perform a hot-swap on virtual machines if needed by shifting virtual machines VMs from the at-risk server to low-risk servers. Servers having a health score indicating high risk are indicated on a visual display called a heat map. The heat map quickly provides a visual indication to the telco person of identities of at-risk servers. The heat map can also indicate commonalities between at-risk servers, such as if the at-risk servers are correlated in terms of protocols in use, if the at-risk servers are correlated in terms of geographic location, server manufacturer, server OS load, or the particular hardware failure mechanism predicted for the at-risk servers.

### FIELD

Embodiments relate to a telco operator managing a cloud of servers for high availability.

### BACKGROUND

A cellular network may use a cloud of servers to provide a portion of a cellular telecommunications network. Availability of services may suffer if a server in the cloud of servers fails while the server is supporting communication traffic. An example of a failure is a hardware failure in which a server becomes unresponsive or re-boots unexpectedly.

### SUMMARY

A problem with current methods of reaching high availability is that a server fails before action is taken. Also, the reason for the server failure is only established by an after-the-failure diagnosis.

Applicants have recognized that failures occur when traffic flows in and certain processes run, then suddenly a fragile server fails.

Applicants have recognized early stages of symptoms that cause a problem.

Applicants have recognized that server failures depend both on an inherent state of a server (hardware physical condition) plus other conditions external to the server. Taken together the server state and the external conditions cause a failure at a particular point in time. Applicants have recognized that one of the external conditions is traffic pattern, for example the flow of bits into a server that caused processes to launch and cause the server to output a flow of bits.

Previous approaches to improving network availability of servers were reactionary in looking for anomaly patterns following a failure event.

Embodiments provided in the present application predict a future failure with some lead time, in contrast to previous approaches which look for patterns of parameters after an error occurs. Thus, in this application, one or more leading indicators are found and applied to avoid server downtime and increase availability of network services to customers.

Applicants have recognized that a fragile server exhibits symptoms under stress before it fails. Traffic patterns are bursty. As a simplified example, consider a value of a statistic, S_{F}, which typically represents a server at a time of hardware failure. In this simplified example, under a bursty traffic pattern a system may produce a statistic value of 0.98*S_{F} (“*” is multiplication; S_{F} is a real number). Note that reaching a value of 1.0*S_{F} is historically associated with failure. That is, detecting when the server is almost broken in this simplified example allows failure prediction since some other future traffic will be even higher. Recognizing this, Applicants provide a solution that takes action ahead of time by weeks or hours depending on system condition and traffic pattern that occurs. Network operators are aware of traffic patterns and Applicants include in the solution considering the nature of a server weakness and immediate traffic expected in determining on how and when to shift load away from an at-risk (fragile) server.

For example, at a next site change management cycle, action may be taken to fix or keep off-line an at-risk server. It is normal to periodically bring a system down (planned downtime, when and as required). This may also be referred to as a maintenance window. When a server is identified that needs attention, embodiments provide that the server load is shifted. The shift can depend on a maintenance window. If a maintenance window is not within forecast of the predicted failure, the load (for example, a virtual machine (VM) running on the at-risk server) is moved promptly without causing user down time.

Thus, embodiments reduce unplanned downtime and reduce effects on a user that would otherwise be caused by unplanned downtime. Planned downtime is acceptable. Customers can be contacted.

Thus, a solution provided herein is prediction, with a probability estimate, of a possible future server failure along with an estimated cause of the future server failure. Based on the prediction, the particular server can be evaluated and if the risk is confirmed, load balancing can be performed to move the load (e.g., virtual machines (VMs)) off of the at-risk server onto low-risk servers. High availability of deployed load (e.g., virtual machines (VMs)) is then achieved.

A problem with current methods of processing big data is that there is a delay between when the data is input to a computer for inference and when the computer provides a reliable analysis of the big data. For example, a flow of big data for a practical system may be on the order of 500 parameters per server, twice per minute for 1000 servers. This flow is on the order of 1,000,000 parameters per minute. A flow of this size is not handled by any real-time diagnostic technique.

A solution provided herein is a scalable tree-based artificial intelligence (AI) inference engine to process the flow of data. The architecture of the AI inference engine is scalable, so that increasing from 1000 servers analyzed per minute to 1500 servers analyzed per minute does not require a new optimization of the architecture to handle the flow reliably. This feature indicates scalability for big data. Embodiments identify one or more leading indicators (including server parameters and statistic types) which reliably predict hardware failure in servers using server parameters. Thus, embodiments provide an AI inference engine which is scalable in terms of the number of servers that can be monitored. This allows a telco operator to monitor cloud-based virtual machines (VMs) and perform a hot-swap on virtual machines if needed by shifting virtual machines (VMs) from the at-risk server to low-risk servers.

Another problem of processing big data for a telco operator is data overload. It is challenging for a telco person monitoring a large network serving millions of user equipments (UEs), such as a cellular radio system in a major city like Tokyo, to analyze 500 parameters from 1000 servers once per minute, once per ten minutes or once per hour, to predict a particular server that may fail and failure causes.

Solutions provided herein allow a telco person to learn a health score of any server, and those servers having a health score indicating high risk are indicated on a visual display called a heat map. The heat map quickly provides a visual indication to the telco person associated with at-risk servers. The heat map can also indicate commonalities between at-risk servers, such as if the at-risk servers are correlated in terms of protocols in use, geographic location, server manufacturer, server OS (operating system) load, or the particular hardware failure mechanism predicted for the at-risk servers. The heat map allows a telco person to find out in real time or near-real time, the health of their overall network. The heat map gives the telco person the essential information about their system derived from the flow of big data, in a humanly-understandable way (before a VM crashes and UE service is degraded by lost or delayed data).

As an example, model training in an embodiment is performed as follows. The apparatus performing the following may be referred to as the model builder. This model training may be performed every few weeks. Also, the model may be adaptively updated as new data arrives. A server is also referred to as a “node.” In some embodiments, the model training is performed by: 1) loading historical data for servers (may be, for example, approximately 6,000 servers); 2) setting targets based on if and when a server failed (obtain labels by labelling nodes by failure time, using the data), 3) computing statistical features of the data, and adding the statistical features to the data object, 4) identifying leading indicators for failures, this identification is based on the data and the labels, 5) training an AI model with the newly found leading indicators, this training is based on the data, the leading indicators and the labels, and 6) optimizing the AI model by performing hyperparameter tuning and model validation. The output of the above approach is the AI model.

As an example for using the model, the following inference operations may be performed at a period of a minute or so (e.g., twice per minute, once per minute, once every ten minutes, once per hour, or the like). 1) obtain a list of all servers (may be, for example, approximately 6,000 servers), 2) instantiate a variable “predictions_list” as a list, 3) obtain the AI model from the model builder, 4) perform this step “4” for each node (“current node being predicted”), this step “4” comprises the steps listed in the following as 4a, 4b, etc. 4a) extract (by using, for example, Prometheus and/or Telegraf) approximately 500 server metrics (server parameters) for the current node being predicted, and store the extracted server metrics in an object called node data, 4b) add statistical features such as spectral residuals and time series features to the node data (these are determined by the node data consisting of server metrics). At inference time, the server metrics used as a basis for spectral residual and other statistic types (see the discussion of Table 4 below) may be a subset of about 10-15 of the server metrics used for model building, 4c) obtain anomaly predictions (usually there is no anomaly) for the current node being predicted by inputting the node data to the AI model, 4d) add the anomaly predictions (possibly indicating no anomaly) of the current node being predicted to a global data structure which includes the predictions for all the servers, 4d) is the last step in per-node operation of step 4), which is a step of returning to step 4a) and repeating steps 4a)-4d) for the next node until the nodes of the list have been evaluated, 5) sort the nodes based on the inference of the AI model to obtain a data structure including node health scores, the input for the sort function is the predictions included in the global data structure, 6) generate a heat map based on the node health scores, 7) present the heat map as a visual display, 8) take action, if needed, to shift load from an at-risk server to a low-risk server, thereby achieving high availability of the services provided by the servers.

### Model Builder

Provided herein is a method of building an artificial intelligence (AI) model using big data, the method comprising: forming a matrix of data time series and statistic types, wherein each row of the matrix corresponds to a time series of a different server parameter of one or more server parameters and each column of the matrix refers to a different statistic type of one or more statistic types; determining a first content of the matrix at a first time; determining a second content of the matrix at a second time; determining at least one leading indicator by processing at least the first content and the second content; building a plurality of decision trees based on the at least one leading indicator; and outputting the plurality of decision trees as the AI model.

In some embodiments, the one or more statistic types includes one or more of a first moving average of the server parameter, a first entire average of the server parameter, a z-score of the server parameter, a second moving average of standard deviation of the server parameter, a second entire average of standard deviation of the server parameter, and/or a spectral residual of the server parameter.

In some embodiments, the server parameter includes a field programmable gate array (FPGA) parameter, a CPU parameter, a memory parameter, and/or an interrupt parameter.

In some embodiments, the FPGA parameter is message queue, the CPU parameter is load and/or processes, the memory parameter is IRQ or DISKIO, and the interrupt parameter is IPMI and/or IOWAIT. Further explanation of these parameters is given here.

IRQ—interrupt request routine;

DISKIO—disk input/output operation

IPMI—intelligent platform management interface, more information can be found at the following URLs:

https://www.zenlayer.com/blog/what-is-ipmi/

https://phoenixnap.com/blog/what-is-ipmi

I/O Wait—Percentage of time that the CPU or CPUs were idle during which the system had an outstanding disk I/O request.

In some embodiments, each decision tree of the plurality of decision trees includes a plurality of decision nodes, a corresponding plurality of decision thresholds are associated with the plurality of decision nodes, and the building the plurality of decision trees comprises choosing the plurality of decision thresholds to detect anomaly patterns.

In some embodiments, the big data comprises a plurality of server diagnostic files associated with a first server of a plurality of servers, a dimension of the plurality of server diagnostic files indicating that there is a first number of files in the plurality of server diagnostic files. In some embodiments, the first number is more than 1,000.

In some embodiments, the first time interval is about one month.

In some embodiments, a most recent version of a first file of the plurality of server diagnostic files associated with the first server is obtained about every 1 minutes, every 10 minutes or every hour.

In some embodiments, a second number of copies of the first file is on an order of an expression M, wherein M=1/minute*60 min/hour*24 hours/day*30 days per month*the first time interval=50,000, a dimension of the one or more server parameter is greater than 500.

In some embodiments, the plurality of decision trees are configured to process the second number of copies of the first file to make a prediction of hardware failure related to the first node.

In some embodiments, a second dimension of the plurality of servers indicating that there is a second number of servers in the plurality of servers. In some embodiments, the second number of servers is greater than 1,000.

In some embodiments, the plurality of decision trees are configured to implement a light-weight process, and the plurality of decision trees are configured to output a health statistic for each server of the plurality of servers, and the plurality of decision trees being scalable with respect to the second number of servers, wherein scalable includes a linear increase in the number of servers causing only a linear increase in the complexity of the plurality of decision trees.

### Model Builder Apparatus

Also provided herein is a model builder apparatus (e.g., a model builder computer) comprising: one or more processors; and one or more memories, the one or more memories storing a computer program, the computer program including: interface code configured to obtain server log data, and calculation code configured to: determine at least one leading indicator, and build a plurality of decision trees based on the at least one leading indicator, wherein the interface code is further configured to send the plurality of decision trees, as a trained AI model, to an AI inference engine.

### Inference Engine

Also provided herein is an AI inference engine comprising: one or more processors; and one or more memories, the one or more memories storing a computer program, the computer program including: interface code configured to: receive a trained AI model, and receive a flow of server parameters from a cloud of servers; calculation code configured to: determine at least one leading indicator for each server of a cloud of servers, wherein the at least one leading indicator is based on the flow of server parameters, and determine, based on a plurality of decision trees corresponding to the trained AI model, a plurality of health scores corresponding to servers of the cloud of servers, wherein the interface code is further configured to output the plurality of health scores to an operating console computer.

### Operating Console Computer

Also provided herein is an operating console computer comprising: a display, a user interface, one or more processors; and one or more memories, the one or more memories storing a computer program, the computer program including: interface code configured to receive a plurality of health scores, and user interface code configured to: present, on the display, at least a portion of the plurality of health scores to a telco person, and receive input from the telco person, wherein the interface code is further configured to communicate with a cloud management server to cause, based on the plurality of health scores, a shift of a virtual machine (VM) from an at-risk server to a low-risk server.

### System

Also provided herein is a system comprising: the inference engine described above which is configured to receive a flow of server parameters from a cloud of servers, the operating console computer described above, and the cloud of servers.

### Another System

Also provided herein is another system comprising: the model builder computer described above, the inference engine described above which is configured to receive a flow of server parameters from a cloud of servers, the operating console computer described above, and the cloud of servers.

### AI Inference Engine Configured to Predict Hardware Failures

Also provided herein is another AI inference engine configured to predict hardware failures, the AI inference engine comprising: one or more processors; and one or more memories, the one or more memories storing a computer program to be executed by the one or more processors, the computer program comprising: configuration code configured to cause the one or more processors to load a trained AI model into the one or more memories, server analysis code configured to cause the one or more processors to: obtain at least one server parameter in a first file for a first node in a cloud of servers, wherein the at least one server parameter includes at least one leading indicator, compute at least one leading indicator as a statistical feature of the at least one server parameter for the first node, detect at least one anomaly of the first node, reduce the at least one anomaly to a health score, and add an indicator of the at least one anomaly and the health score to a data structure, control code configured to cause the one or more processors to repeat an execution of the server analysis code for N-1 nodes other than the first node, N is a first integer, thereby obtaining a first plurality of the at least one server parameter and forming a plurality of health scores, wherein N is greater than 1000, and presentation code configured to cause the one or more processors to: formulate the plurality of health scores into a visual page presentation, and send the visual page presentation to a display device for observation by a telco person.

In some embodiments of the another inference engine, the first plurality comprises big data, the big data comprises a plurality of server diagnostic files, a first dimension of the plurality of server diagnostic files is M, M is a second integer, and M is more than 1,000.

In some embodiments of the another inference engine, the at least one server parameter includes a field programmable gate array (FPGA) parameter, a CPU parameter, a memory parameter, and/or an interrupt parameter.

In some embodiments of the another inference engine, the FPGA parameter is message queue, the CPU parameter is load and/or processes, the memory parameter is IRQ or DISKIO, and the interrupt parameter is IPMI and/or IOWAIT.

In some embodiments of the another inference engine, the trained AI model represents a plurality of decision trees, wherein a first decision tree of the plurality of decision trees includes a plurality of decision nodes, a corresponding plurality of decision thresholds are associated with the plurality of decision nodes, and the trained AI model is configured to cause the plurality of decision trees to detect anomaly patterns of the at least one leading indicator over a first time interval.

In some embodiments of the another inference engine, the first time interval is about one month.

In some embodiments of the another inference engine, the control code is further configured to update the first plurality of server diagnostic files about once every 1 minute, 10 minutes or 60 minutes.

In some embodiments of the another inference engine, the AI inference engine is configured to predict the health score of the first node based on a number of copies of the first file, wherein the number of copies of the first file is on an order of an expression M, wherein M=1/minute*60 min/hour*24 hours/day*30 days per month*the first time interval=50,000, a second dimension of the at least one server parameter is greater than 500.

In some embodiments of the another inference engine, the at least one server parameter includes a data parameter, and the at least one statistical feature includes one or more of a first moving average of the data parameter, a first entire average over all past time of the data parameter, a z-score of the data parameter, a second moving average of standard deviation of the data parameter, a second entire average of signal of the data parameter, and/or a spectral residual of the data parameter.

### Method

Also provided herein is a method for performing inference to predict hardware failures, the method comprising: loading a trained AI model into the one or more memories; obtaining at least one server parameter in a first file for a first node in a cloud of servers; computing at least one leading indicator as a statistical feature of the at least one server parameter for the first node; detecting zero or more anomalies of the first node; reducing the a result of the detecting to a health score; adding an indicator of the zero or more anomalies and the health score to a data structure; repeating the obtaining, the computing, the detecting, the reducing and the adding for N-1 nodes other than the first node, N is a first integer, thereby obtaining a first plurality of the at least one server parameter and forming a plurality of health scores, wherein N is greater than 1000; formulating the plurality of health scores into a visual page presentation; and sending the visual page presentation to a display device for observation by a telco person.

### Heat Map Interface Apparatus for Interaction with Telco Maintenance Operator

Also provided herein is yet another system comprising: an operating console computer including the display device, a user interface, and a network interface; and an AI inference engine comprising: one or more processors; and one or more memories, the one or more memories storing a computer program, the computer program including: interface code configured to: receive a trained AI model, and receive a flow of server parameters from a cloud of servers, calculation code configured to: determine at least one leading indicator for each server of a cloud of servers, wherein the at least one leading indicator is based on the flow of server parameters, and determine, based a plurality of decision trees corresponding to the trained AI model, a plurality of health scores corresponding to servers of the cloud of servers, wherein the interface code is further configured to output the plurality of health scores to an operating console computer, wherein the operating console computer is configured to: display the visual page presentation on the display device, receive on the user interface responsive to the visual page presentation on the display device, a command from the telco person, and send, via the network interface, a request to a cloud management server, wherein the request identifies the first node, and the request indicates that virtual machines associated with a telco of the telco person are to be shifted from the first node to another server.

An additional system is provided comprising: an operating console computer including a display device, a user interface, and a second network interface; and an inference engine comprising: a first network interface; one or more processors; and one or more memories, the one or more memories storing a computer program to be executed by the one or more processors, the computer program comprising: prediction code configured to cause the one or more processors to form a data structure comprising anomaly predictions and health scores for a first plurality of nodes, sorting code configured to cause the one or more processors to sort the first plurality of nodes based on the health scores, generating code configured to cause the one or more processors to generate a heat map based on the sorted plurality of nodes, presentation code configured to cause the one or more processors to: formulate the heat map into a visual page presentation, wherein the heat map includes a corresponding health score for each node of the first plurality of nodes, and send the visual page presentation to the display device for observation by a telco person.

In some embodiments of the additional system, the heat map is configured to indicate a first trend based on a first plurality of predicted node failures of a corresponding first plurality of nodes, wherein the first trend is correlated with a first geographic location within a first distance of each geographic location of each node of the first plurality of nodes.

In some embodiments of the additional system, the heat map is configured to indicate a second trend based on a second plurality of predicted node failures of a second plurality of nodes, wherein the second trend is correlated with a same protocol in use by each node of the second plurality of nodes.

In some embodiments of the additional system, the heat map is configured to indicate a second trend based on a second plurality of predicted node failures of a second plurality of nodes, wherein the second trend is correlated with a same protocol in use by each node of the second plurality of nodes.

In some embodiments of the additional system, the heat map is configured to indicate a spatial trend based on a third plurality of predicted node failures of a third plurality of nodes, and the heat map is further configured to indicate a temporal trend based on a fourth plurality of predicted node failures of a fourth plurality of nodes.

In some embodiments of the additional system, the operating console computer is configured to: receive, responsive to the visual page presentation and via the user input device, a command from the telco person; and send a request to a cloud management server, wherein the request identifies a first node, and the request indicates that virtual machines associated with a telco of the telco person are to be shifted from the first node to another server.

In some embodiments of the additional system, the operating console computer is configured to provide additional information about a second node when the telco person uses the user input device to indicate the second node.

In some embodiments of the additional system, the additional information is configured to indicate a type of the anomaly, an uncertainty associated with a second health score of the second node, and/or a configuration of the second node.

In some embodiments of the additional system, a type of the anomaly is associated with one or more of a field programmable gate array (FPGA) parameter, an airflow parameter, a CPU parameter, a memory parameter, and/or an interrupt parameter.

In some embodiments of the additional system, the FPGA parameter is message queue, the CPU parameter is load and/or processes, the memory parameter is IRQ or DISKIO, and the interrupt parameter is IPMI and/or IOWAIT.

In some embodiments of the additional system, the network interface code is further configured to cause the one or more processors to form the data structure about once every 1 to 60 minutes.

In some embodiments of the additional system, the presentation code is further configured to cause the one or more processors to update the heat map once every 1 to 60 minutes.

### BRIEF DESCRIPTION OF THE DRAWINGS

FIG. 1 illustrates exemplary logic 1-9 for AI-based hardware maintenance using a leading indicator 1-13, according to some embodiments.

FIG. 2 illustrates an exemplary system 2-9 including a telco operator control 2-1 and servers 1-4 in a cloud of servers 1-5, according to some embodiments.

FIG. 3A illustrates an exemplary system 3-9 including an AI inference engine 3-20 and a heat map 3-41 using the leading indicator 1-13 resulting from server parameters 3-50 which form a flow 3-13, according to some embodiments.

FIG. 3B illustrates the cloud of servers 1-5 including, among many servers, server K, server L, and server 1-8.

FIG. 3C illustrates exemplary illustration of the flow 3-13, in terms of matrices, according to some embodiments.

FIG. 4A illustrates a telco core network 4-20 using the cloud of servers 1-5 and providing service to telco radio network 4-21, according to some embodiments.

FIG. 4B illustrates exemplary details of the telco operator control 2-1 interacting with the telco core network 4-20, according to some embodiments. In some embodiments, the telco core network 4-20 is implemented as an on-prem (“on premises”) cloud.

FIG. 4C illustrates exemplary details of a shift 4-60 to move a load away from an at-risk server, according to some embodiments.

FIG. 5 illustrates an exemplary algorithm flow 5-9 including the leading indicator 1-13 and the heat map 3-41, according to some embodiments.

FIG. 6 illustrates an exemplary heat map 3-41, according to some embodiments.

FIG. 7A illustrates exemplary logic 7-8 for prediction of a hardware failure of server 1-8 based on leading indicator 1-13 and performing a shift 4-60 to a low-risk server 4-62, according to some embodiments.

FIG. 7B illustrates exemplary logic 7-48 for prediction of a hardware failure of server 1-8 using matrices and statistic types to identify the leading indicator 1-13 for support of a scalable AI inference engine, according to some embodiments.

FIG. 8 illustrates exemplary logic 8-8 for receiving data from more than 1000 servers, identifying leading indicator 1-13 using statistical features and predicting the failure of server 1-8 using a scalable AI inference engine, according to some embodiments.

FIG. 9 illustrates exemplary logic 9-9 with further details for realization of the logic of FIGS. 7A, 7B and/or FIG. 8, according to some embodiments.

FIG. 10 illustrates an example decision tree representation (only a portion) of the AI inference engine 3-20, according to some embodiments.

FIG. 11 illustrates an example decision tree representation (only a portion) of the AI inference engine 3-20 including probability measures, according to some embodiments.

FIG. 12 illustrates, for a healthy server, exemplary time series data of different statistics types applied to server parameters 3-50, according to some embodiments.

FIG. 13 illustrates, for at risk server 1-8, exemplary time series data of different statistics types applied to server parameters 3-50, according to some embodiments.

FIG. 14 illustrates an exemplary hardware and software configuration of any of the apparatuses described herein.

### DETAILED DESCRIPTION

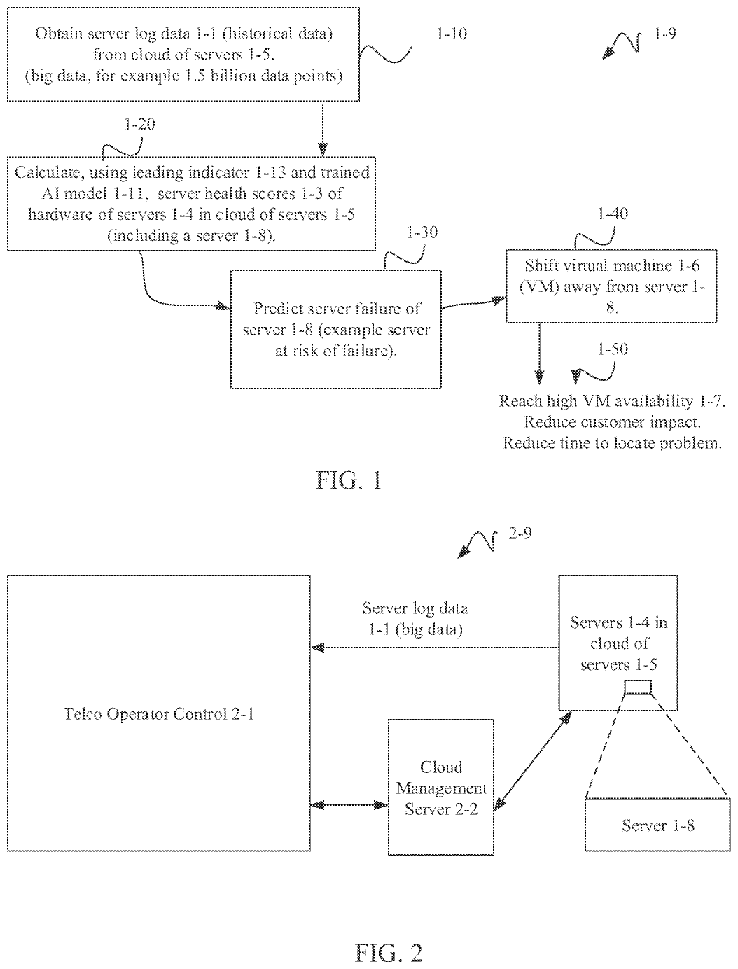

FIG. 1 illustrates exemplary logic 1-9 for AI-based hardware maintenance using a leading indicator 1-13. At operation 1-10, the logic 1-9 obtains server log data 1-1 from a cloud of servers 1-5 (which includes an example server 1-8). At operation 1-20, logic 1-9 calculates, using leading indicator 1-13 and trained AI model 1-11, server health scores 1-3 of hardware of servers 1-4 in the cloud of servers 1-5. The logic 1-9 then calculates failure of, for example, server 1-8 at operation 1-30. At 1-40, the logic shifts a virtual machine (VM) 1-6 away from server 1-8 to a low-risk server. A result, 1-50, is then obtained of reaching high VM availability 1-7, reducing customer impact (for example, reducing delays and lost data at UEs) and reducing time to locate a problem for a telco operator.

The trained AI model 1-11 processes statistics of server parameters. Example statistic types are z-score, running average, rolling average, standard deviation (also called sigma), and spectral residual. A z-score may be defined as (x−μ)/σ, where x is a sample value, μ is a mean and σ is a standard deviation. An outlier data point has a high z-score. A running average computes an average of only the last N sample values. A rolling average computes an average of all available sample values. The variance of the data may be indicated as σ² and the root mean square value (standard deviation) as σ, or sigma. A running average computes an average of only the last N values of sigma. A rolling average computes an average of all available sigma values. Spectral residual is a time-series anomaly detection technique. Spectral residual uses an A(f) variable, which is an amplitude spectrum of a time series of samples. The spectral residual is based on computing a difference between a log of A(f) and an average spectrum of the log of A(f). More information on spectral residual can be found at the paper index arXiv:1906.03821v1 (URL) https://arxiv.org/abs/1906.03821) referring to the paper “Time-Series Anomaly Detection Service at Microsoft” by H. Ren et al.

FIG. 2 illustrates an exemplary system 2-9 including a telco operator control 2-1 and servers 1-4 in a cloud of servers 1-5. Server log data 1-1, which can be big data, flows from the cloud of servers 1-5 to the telco operator control 2-1. In general, a telco operator may be a corporation operating a telecommunications network. The cloud of servers includes the example server 1-8. The telco operator control 2-1, in some embodiments, manages the cloud of servers 1-5 using a cloud management server 2-2. The cloud of servers may be on prem (“on premises”) in one or more buildings owned or leased by the telco operator and the servers 1-4 may be the property of the telco operator control 2-1. In some embodiments, the servers 1-4 may be the property of a cloud vendor (not shown) and the telco operator coordinates, with the cloud vendor, instantiation of virtual machines (VMs) on the servers 1-4.

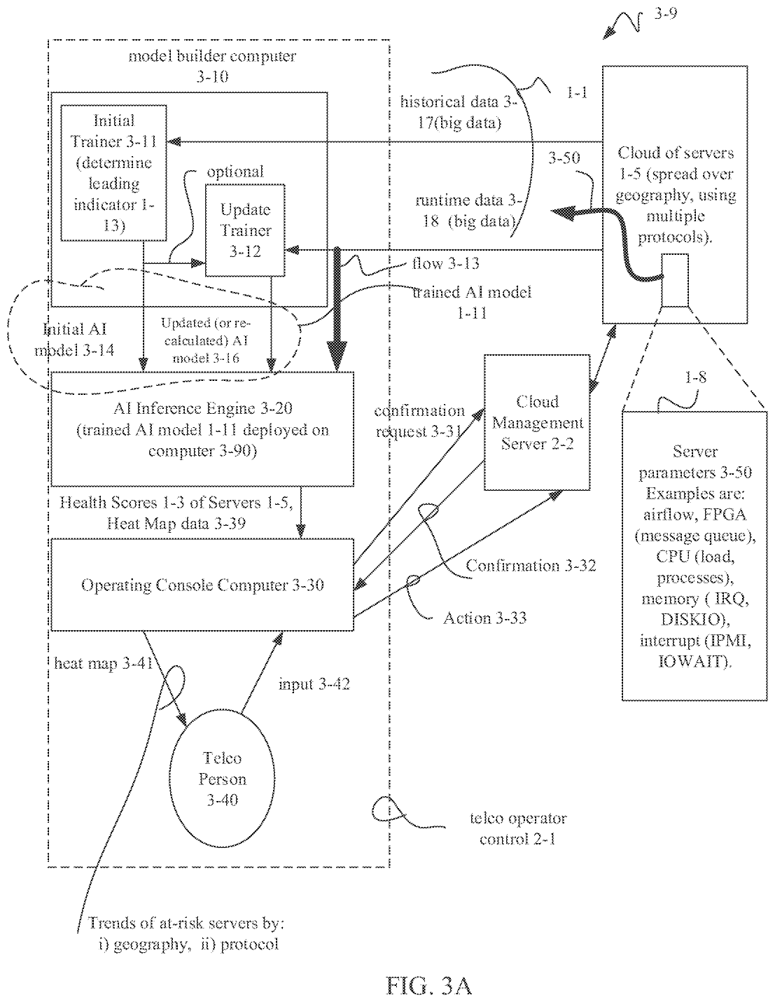

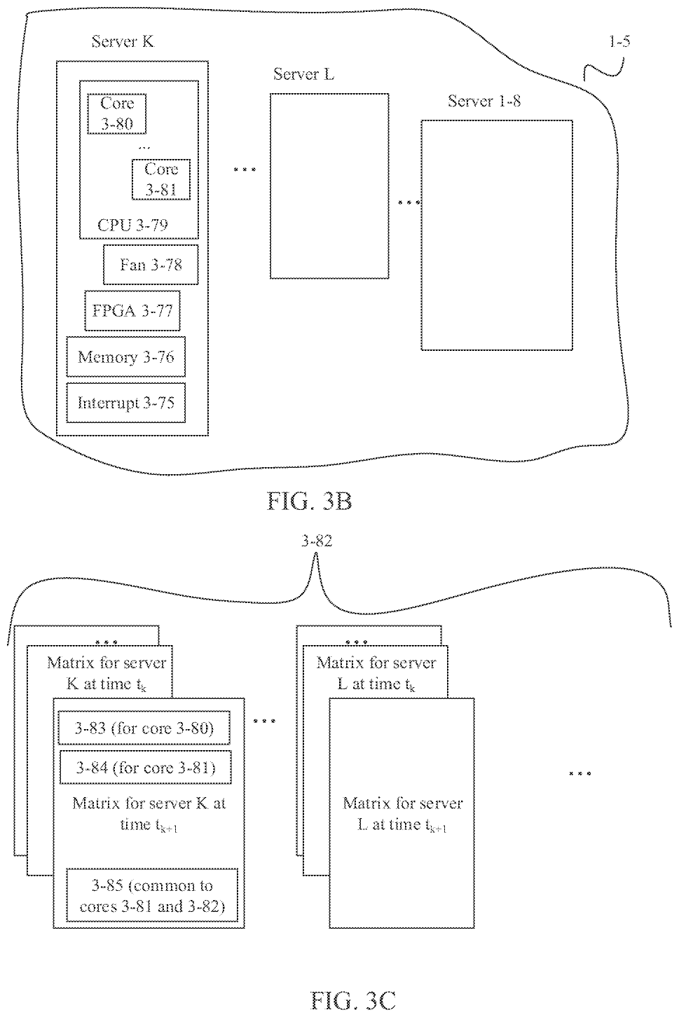

FIG. 3A illustrates an exemplary system 3-9 including an AI inference engine 3-20 and a heat map 3-41 based on the leading indicator 1-13. The leading indicator 1-13 results from server parameters 3-50. Server parameters 3-50 are included in the flow 3-13.

On the left is shown telco operator control 2-1, according to an embodiment. In the upper right is shown the cloud of servers 1-5. A zoom-in box is shown on the right indicating the server 1-8 and also indicating server parameters 3-50 which are the basis of the flow 3-13 from the cloud of servers 1-5 to the telco operator control 2-1. In the middle right is shown the cloud management server 2-2.

Server log data 1-1 flows from the cloud of servers 1-5 to the telco operator control 2-1. The server log data 1-1 includes historical data 3-17 and runtime data 3-18. The historical data 3-17 is processed by an initial trainer 3-11 in a model builder computer 3-10 to determine a leading indicator 1-13. The leading indicator 1-13 may include one or more leading indicators. Examples of statistic types are as follows for a leading indicator being cpu usage iowait (a server parameter): 1) sample values of cpu usage iowait, 2) spectral residual values of cpu usage iowait, 3) rolling average of z-score of cpu usage iowait, 4) running average of cpu usage iowait 5) rolling average of the z-score of the spectral residual of cpu usage iowait sample values, and 6) running average of the z-score of the spectral residual of cpu usage iowait sample values.

The following server parameters are well-known to one skilled in the art: airflow, FPGA (message queue), CPU (load, processes), memory (IRQ, DISKIO), interrupt (IPMI, IOWAIT).

Server parameters can be downloaded using software packages. Example software packages are Telegraf and Prometheus.

Further details of Telegraf and Prometheus can be found at the follow URLs.

A website for Telegraf is

https://github.com/influxdata/telegraf/blob/master/docs/CONFIGURATION.md.

A URL for Prometheus is provided here.

https://github.com/influxdata/telegraf/tree/master/plugins/inputs/prometheus.

As mentioned above, Telegraf and Prometheus are examples of software packages for obtaining server parameters. Telegraf and Prometheus are examples of open source tools which collect server parameters. Open source tools are not proprietary. The server parameters are characteristics of a server.

Activity in FIG. 3A flows in a counter-clockwise fashion starting from and ending at the cloud of servers 1-5.

The initial trainer 3-11 and update trainer 3-12 provide the trained AI model 1-11 to the AI inference engine 3-20. During model-building time, the initial trainer 3-11 determines leading indicator 1-13 based on statistics of the server parameters and builds a plurality of decision trees for processing of the flow 3-13 (which includes the runtime data 3-18 representing samples of the server parameters 3-50). For example, in some embodiments, the plurality of decision trees, represented by initial trained AI model 3-14, is sent to computer 3-90. In some embodiments, the model builder computer 3-10 pushes the trained AI model into other servers as a software package accessible by an operating system kernel; the software package may be referred to as an SDK. AI model 3-14 and computer 3-90 together form AI inference engine 3-20. That is, an AI model is a component of an inference engine. The AI inference engine 3-20 will then process flow 3-13 (which includes the runtime data 3-18) with the plurality of decision trees of the AI model.

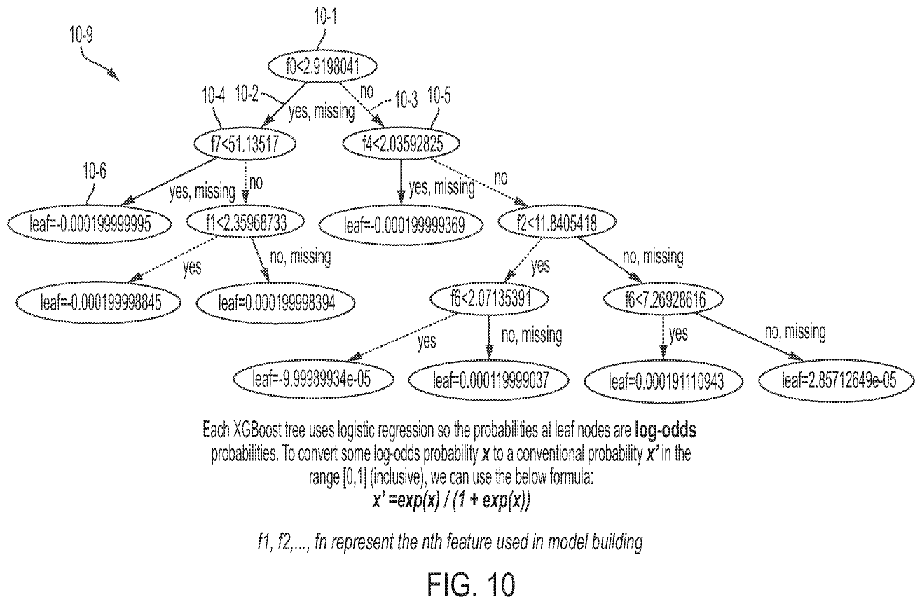

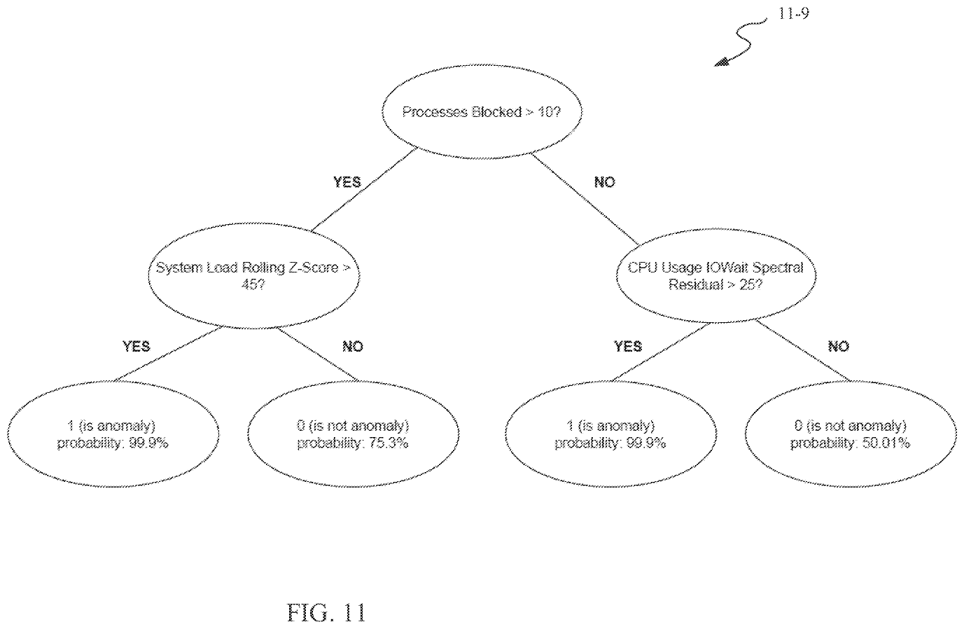

As an example of a decision tree, see FIG. 10. As an example implementation, the plurality of decision trees may be built using a technique known as XGBoost. A web site describing XGBoost is as follows (hereafter “XGBoost Page”):

https://xgboost.readthedocs.io/en/latest/. FIG. 11 also provides an example of a decision tree. The probability values are determined by a voting-type count among the plurality of decision trees (not shown in FIG. 11). FIGS. 10-11 are discussed further below.

Once inference has begun (in runtime), the update trainer 3-12 provides updated AI model 3-16. The updated AI model 1-16 includes updated values for configuration of the plurality of decision trees.

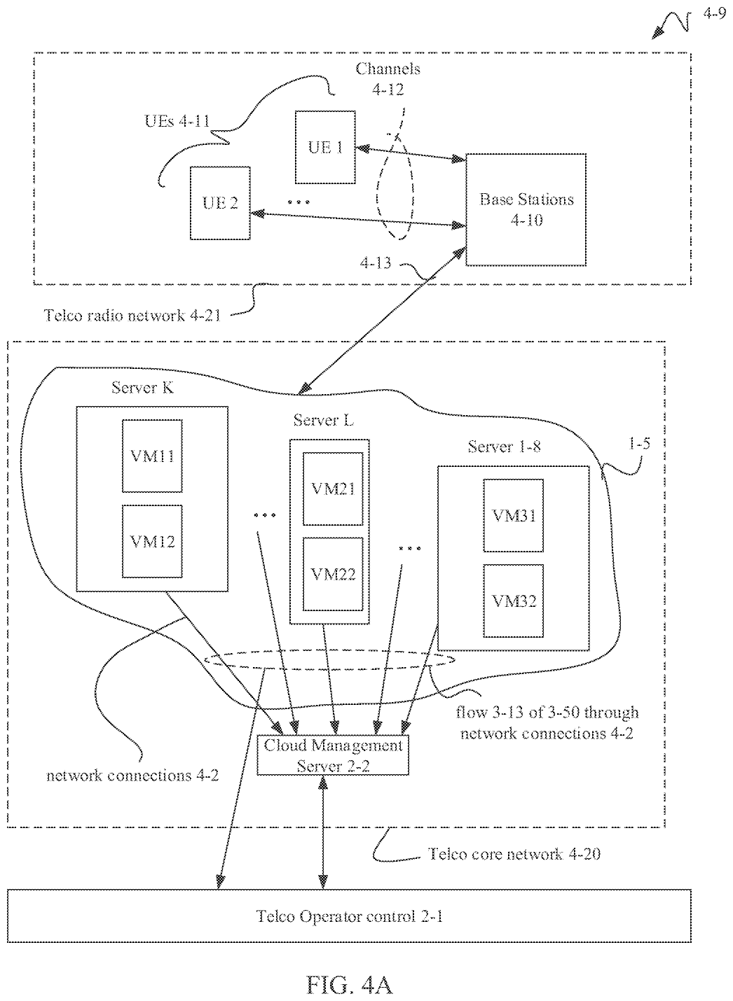

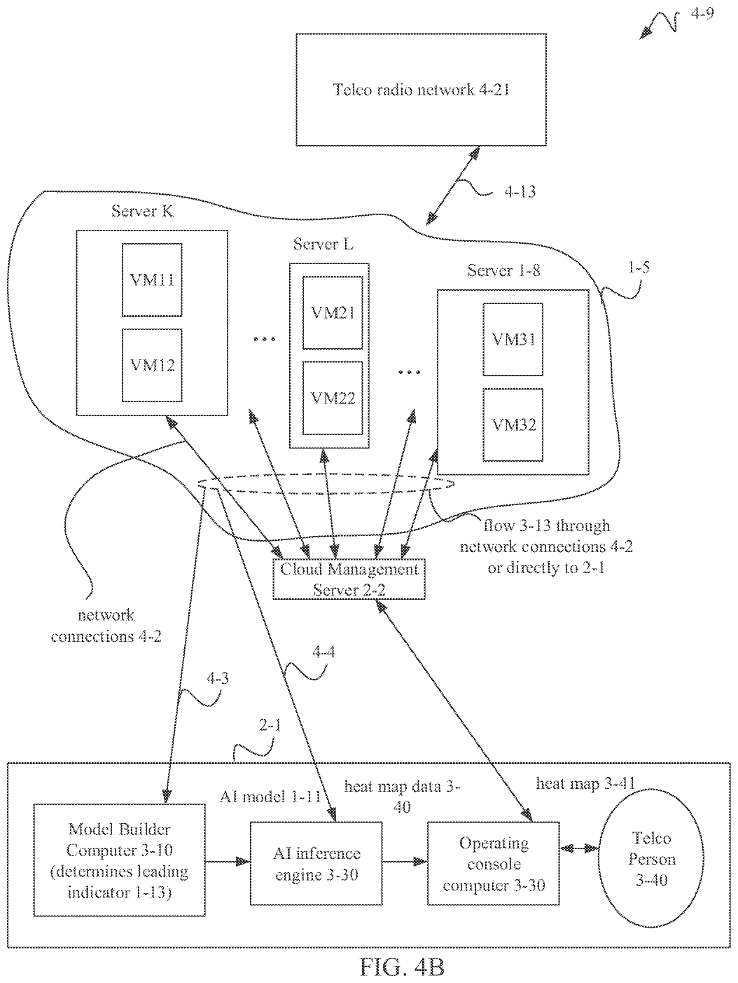

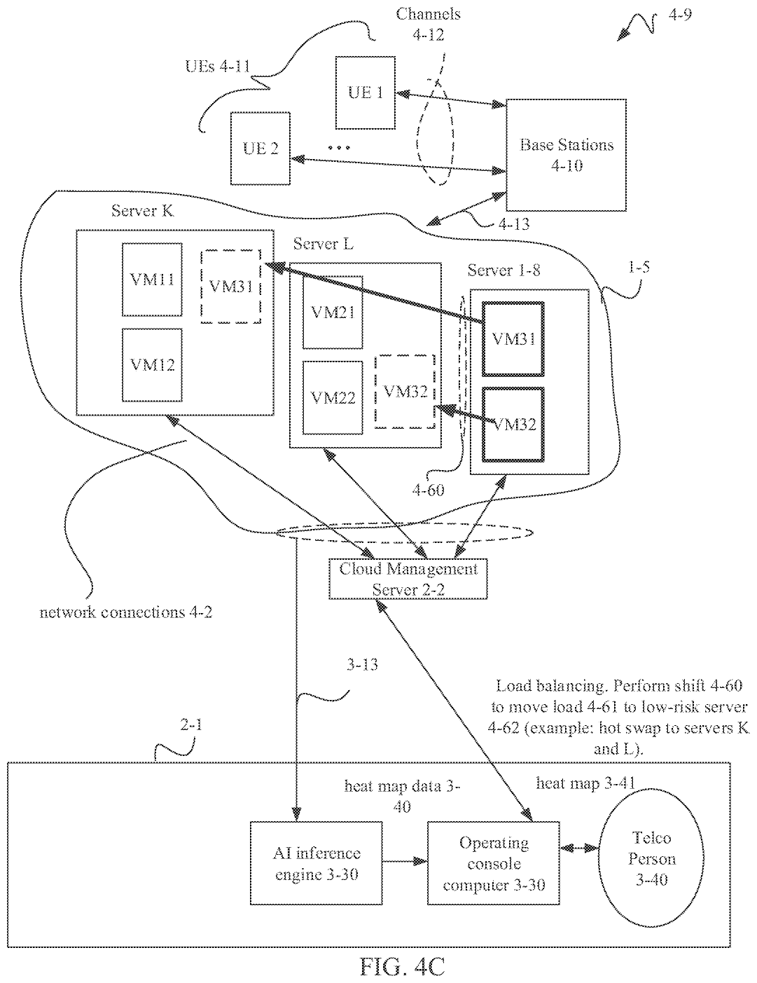

Exemplary values for several statistic types of leading indicator are shown below in Table 1 for a healthy server (e.g., server L or server K of FIG. 4C) and are shown in below Table 2 for an at-risk server (e.g., server 1-8 of FIG. 4C).

After the model has been built, it is provided to the AI inference engine 3-20 as trained AI model 1-11. The trained AI model 1-11 specifies the decision trees. At runtime, the flow 3-13 enters the AI inference engine 3-20 and moves through the plurality of decision trees. For each server, a health score 1-3 is generated based on one or more leading indicators. The function to determine the health score may be an average, a weighted average or a maximum, for example. A reason for the score is also provided. The reason lists the main reason for the anomaly if the health score 1-3 indicates something might be wrong with the server. The health scores 1-3 are used to prepare a presentation page, e.g., in HTML code. The presentation page is referred to in FIG. 3A as heat map data 3-39.

TABLE 1
Healthy Server, statistics of cpu usage iowait leading indicator for 1 hour.

| | | Cpu usage | Cpu usage | Cpu usage | Cpu usage | Cpu usage |
|---|---|---|---|---|---|---|
| | Cpu | iowait | iowait | iowait | iowait spectral | iowait spectral |
| | usage | spectral | rolling | running | residual rolling | residual |
| Date_Time | iowait | residual | zscore | zscore | zscore | running zscore |
| May 1, 2021 21:00 | 0.2502 | 0.26684 | 1.721084 | 0.378543 | 0.561595 | 0.139446 |
| May 1, 2021 21:01 | 0.2001 | −0.6347 | 0.832126 | 0.246019 | 0.880792 | 0.544086 |
| May 1, 2021 21:02 | 0.2834 | 0.517611 | 2.158943 | 0.465941 | 1.026866 | 0.330029 |
| May 1, 2021 21:03 | 0.15 | −0.84059 | 0.000217 | 0.113501 | 1.256596 | 0.700449 |
| May 1, 2021 21:04 | 0.1334 | −0.51266 | 0.293436 | 0.069613 | 0.642726 | 0.451216 |
| May 1, 2021 21:05 | 0.10004 | −0.66729 | 0.830961 | 0.018618 | 0.922693 | 0.568371 |
| May 1, 2021 21:06 | 0.1167 | −0.25385 | 0.520452 | 0.025428 | 0.127893 | 0.254189 |
| May 1, 2021 21:07 | 0.05002 | 0.80077 | 1.666102 | 0.150886 | 1.858888 | 0.546879 |
| May 1, 2021 21:08 | 0.1167 | −0.739 | 0.497707 | 0.025547 | 1.038496 | 0.623149 |
| May 1, 2021 21:09 | 0.2834 | 1.632118 | 2.294212 | 0.466762 | 3.302239 | 1.17894 |
| May 1, 2021 21:10 | 0.10004 | 0.446103 | 0.771687 | 0.018927 | 1.027378 | 0.27675 |
| May 1, 2021 21:11 | 0.2334 | 0.544083 | 1.420496 | 0.334212 | 1.174194 | 0.351101 |
| May 1, 2021 21:12 | 0.0833 | −0.72052 | 1.044879 | 0.063487 | 1.010584 | 0.610525 |
| May 1, 2021 21:13 | 0.1 | −0.29881 | 0.74029 | 0.019308 | 0.270066 | 0.289493 |
| May 1, 2021 21:14 | 0.1167 | −0.68798 | 0.442872 | 0.025032 | 0.937013 | 0.585435 |
| May 1, 2021 21:15 | 0.1497 | −0.7891 | 0.088912 | 0.112428 | 1.085365 | 0.662071 |
| May 1, 2021 21:16 | 0.1666 | −0.75104 | 0.365762 | 0.157399 | 0.99918 | 0.632728 |
| May 1, 2021 21:17 | 0.2001 | −0.29057 | 0.901444 | 0.246105 | 0.233998 | 0.281831 |
| May 1, 2021 21:18 | 0.1833 | −0.89161 | 0.598474 | 0.201602 | 1.236493 | 0.739447 |
| May 1, 2021 21:19 | 0.2168 | −0.05304 | 1.137749 | 0.290355 | 0.180215 | 0.100252 |
| May 1, 2021 21:20 | 0.15 | −0.19882 | 0.01788 | 0.112823 | 0.069674 | 0.211299 |
| May 1, 2021 21:21 | 0.10004 | −0.36204 | 0.78834 | 0.020087 | 0.356586 | 0.335631 |
| May 1, 2021 21:22 | 0.03336 | 0.40681 | 1.843113 | 0.197383 | 0.937335 | 0.2508 |
| May 1, 2021 21:23 | 0.1833 | 0.640652 | 0.594907 | 0.201678 | 1.296584 | 0.429078 |
| May 1, 2021 21:24 | 0.1167 | −0.71947 | 0.472142 | 0.024241 | 0.977972 | 0.608991 |
| May 1, 2021 21:25 | 0.1667 | −0.82788 | 0.338782 | 0.157463 | 1.127883 | 0.691411 |
| May 1, 2021 21:26 | 0.15 | 0.10825 | 0.052895 | 0.112864 | 0.444546 | 0.023642 |
| May 1, 2021 21:27 | 0.1167 | −0.62786 | 0.499699 | 0.02404 | 0.767634 | 0.538539 |
| May 1, 2021 21:28 | 0.05002 | 0.987434 | 1.561608 | 0.153679 | 1.992697 | 0.695683 |
| May 1, 2021 21:29 | 0.1334 | −0.42719 | 0.18631 | 0.068746 | 0.433069 | 0.385591 |
| May 1, 2021 21:30 | 0.2168 | 1.45538 | 1.151317 | 0.291087 | 2.665671 | 1.053475 |
| May 1, 2021 21:31 | 0.03336 | 0.475717 | 1.795358 | 0.198467 | 0.945726 | 0.303864 |
| May 1, 2021 21:32 | 0.05 | −0.07815 | 1.45942 | 0.153996 | 0.047618 | 0.119727 |
| May 1, 2021 21:33 | 0.0667 | −0.57754 | 1.150092 | 0.109281 | 0.76712 | 0.501639 |
| May 1, 2021 21:34 | 0.1334 | 0.065386 | 0.084819 | 0.068953 | 0.258007 | 0.009514 |
| May 1, 2021 21:35 | 0.1334 | −0.16996 | 0.044416 | 0.068926 | 0.091154 | 0.18964 |
| May 1, 2021 21:36 | 0.01666 | 1.069364 | 1.96003 | 0.243217 | 1.957344 | 0.759334 |
| May 1, 2021 21:37 | 0.10004 | −0.38181 | 0.542304 | 0.020166 | 0.46129 | 0.352409 |
| May 1, 2021 21:38 | 0.1501 | 0.239907 | 0.281429 | 0.113892 | 0.5686 | 0.124004 |
| May 1, 2021 21:39 | 0.0834 | 1.152775 | 0.815261 | 0.064845 | 2.034423 | 0.823513 |
| May 1, 2021 21:40 | 0.2334 | 0.498529 | 1.604046 | 0.336822 | 0.906659 | 0.321551 |
| May 1, 2021 21:41 | 0.3 | 1.575627 | 2.595911 | 0.515174 | 2.560394 | 1.147214 |
| May 1, 2021 21:42 | 0.0834 | 0.664282 | 0.840006 | 0.065516 | 1.034021 | 0.44756 |
| May 1, 2021 21:43 | 0.1835 | 0.034586 | 0.665907 | 0.202759 | 0.060569 | 0.035516 |
| May 1, 2021 21:44 | 0.03336 | −0.28314 | 1.599379 | 0.199762 | 0.422307 | 0.279238 |
| May 1, 2021 21:45 | 0.15 | −0.80187 | 0.159716 | 0.113205 | 1.231825 | 0.677196 |
| May 1, 2021 21:46 | 0.0833 | −0.66885 | 0.87233 | 0.065816 | 1.003131 | 0.574714 |
| May 1, 2021 21:47 | 0.2168 | 0.45324 | 1.143294 | 0.292464 | 0.679866 | 0.287064 |
| May 1, 2021 21:48 | 0.05002 | 1.262723 | 1.386646 | 0.155428 | 1.874856 | 0.908646 |
| May 1, 2021 21:49 | 0.2834 | 0.628634 | 2.13201 | 0.471581 | 0.88084 | 0.420985 |
| May 1, 2021 21:50 | 0.25 | 0.662382 | 1.545301 | 0.381501 | 0.901856 | 0.446725 |
| May 1, 2021 21:51 | 0.2168 | −0.42766 | 1.025321 | 0.292101 | 0.727279 | 0.39123 |
| May 1, 2021 21:52 | 0.1833 | −0.76568 | 0.561048 | 0.20206 | 1.201544 | 0.650925 |
| May 1, 2021 21:53 | 0.2834 | 1.032527 | 1.996382 | 0.471184 | 1.459389 | 0.732187 |
| May 1, 2021 21:54 | 0.15 | −0.66476 | 0.042404 | 0.112029 | 1.02199 | 0.573626 |
| May 1, 2021 21:55 | 0.1334 | −0.54379 | 0.182421 | 0.067307 | 0.817094 | 0.480274 |
| May 1, 2021 21:56 | 0.0834 | −0.37102 | 0.879944 | 0.067462 | 0.562605 | 0.3471 |
| May 1, 2021 21:57 | 0.1835 | −0.76695 | 0.525286 | 0.202153 | 1.11902 | 0.65173 |
| May 1, 2021 21:58 | 0.2168 | 0.413045 | 0.990969 | 0.291859 | 0.600264 | 0.257155 |
| May 1, 2021 21:59 | 0.2334 | 0.914374 | 1.197821 | 0.336483 | 1.296603 | 0.643186 |
| May 1, 2021 21:00 | 0.2502 | 0.26684 | 1.721084 | 0.378543 | 0.561595 | 0.139446 |

TABLE 2
At-risk Server, statistics of cpu usage iowait leading indicator for 1 hour.

| | | | | | Cpu usage | Cpu usage |
|---|---|---|---|---|---|---|
| | Cpu | Cpu usage | Cpu usage | Cpu usage | iowait spectral | iowait spectral |
| | usage | iowait spectral | iowait rolling | iowait running | residual rolling | residual |
| Date_Time | iowait | residual | zscore | zscore | zscore | running zscore |
| May 1, 2021 10:00 | 0.0667 | −0.652618057 | 0.319114765 | 0.01808973 | 0.361011338 | 0.552306463 |
| May 1, 2021 10:01 | 0.15 | −0.987190057 | 0.267209581 | 0.175771363 | 0.427605498 | 0.780089704 |
| May 1, 2021 10:02 | 0.2168 | −0.59941576 | 0.226678891 | 0.302111079 | 0.330422681 | 0.514262086 |
| May 1, 2021 10:03 | 0.15 | −0.874728853 | 0.271394963 | 0.175251919 | 0.386026932 | 0.701831033 |
| May 1, 2021 10:04 | 0.1667 | −0.971112303 | 0.262522903 | 0.206832083 | 0.401274436 | 0.76684594 |
| May 1, 2021 10:05 | 0.15 | −0.839443067 | 0.275029807 | 0.174898885 | 0.367101374 | 0.675807963 |
| May 1, 2021 10:06 | 0.10004 | −0.887800883 | 0.308454369 | 0.079757121 | 0.365813117 | 0.708076442 |
| May 1, 2021 10:07 | 0.1 | −0.853151381 | 0.309661878 | 0.079574897 | 0.346542507 | 0.683488144 |
| May 1, 2021 10:08 | 0.11676 | −0.969890614 | 0.300180124 | 0.111457576 | 0.365570224 | 0.762590558 |
| May 1, 2021 10:09 | 0.1667 | −0.849840619 | 0.269806728 | 0.206590757 | 0.32571596 | 0.679378647 |
| May 1, 2021 10:10 | 0.15 | −0.86846267 | 0.282349063 | 0.174530874 | 0.319707774 | 0.69132473 |
| May 1, 2021 10:11 | 0.1833 | −0.900494218 | 0.258761006 | 0.237967902 | 0.3024755 | 0.712446209 |
| May 1, 2021 10:12 | 0.1833 | −0.678205985 | 0.260862079 | 0.237762404 | 0.226767491 | 0.559130128 |
| May 1, 2021 10:13 | 0.1333 | −0.771449628 | 0.294781765 | 0.141917271 | 0.219012161 | 0.622511142 |
| May 1, 2021 10:14 | 0.1334 | −0.736454073 | 0.265466372 | 0.142032786 | 0.181173565 | 0.597783411 |
| May 1, 2021 10:15 | 0.1833 | −0.019300214 | 0.196757389 | 0.237474214 | 0.017213043 | 0.104540933 |
| May 1, 2021 10:16 | 0.2167 | −0.738955313 | 0.125433347 | 0.301103498 | 0.282999307 | 0.599153256 |
| May 1, 2021 10:17 | 0.1501 | 0.040579792 | 0.192410576 | 0.17331113 | 1.766759568 | 0.062354353 |
| May 1, 2021 10:18 | 0.2834 | 1.206257702 | 0.522734179 | 0.428887722 | 5.468291258 | 0.740058857 |
| May 1, 2021 10:19 | 0.10004 | 0.127057461 | 0.456591545 | 0.076394586 | 1.995881129 | 0.003976174 |
| May 1, 2021 10:20 | 0.1167 | 0.15240516 | 0.508132177 | 0.108344503 | 2.167782922 | 0.013494912 |
| May 1, 2021 10:21 | 0.2001 | 0.942170295 | 0.768039828 | 0.268560626 | 4.314006333 | 0.558174146 |
| May 1, 2021 10:22 | 0.1167 | −0.64283012 | 0.503265947 | 0.107904965 | 0.027272424 | 0.536173156 |
| May 1, 2021 10:23 | 0.05002 | 0.41716198 | 1.486968486 | 0.020588648 | 2.494137193 | 0.196266933 |
| May 1, 2021 10:24 | 0.11676 | −0.134556416 | 0.443573718 | 0.108054431 | 1.08146954 | 0.185131798 |
| May 1, 2021 10:25 | 0.03336 | −0.351194088 | 2.085461634 | 0.052899399 | 0.60890748 | 0.334790176 |
| May 1, 2021 10:26 | 0.0834 | 0.074454604 | 1.043846813 | 0.043692637 | 1.57611938 | 0.03993454 |
| May 1, 2021 10:27 | 0.10004 | 1.449243356 | 0.740657316 | 0.075846925 | 4.636586812 | 0.912239556 |
| May 1, 2021 10:28 | 0.0834 | −0.607135774 | 1.047321401 | 0.043571443 | 0.072600703 | 0.513475795 |
| May 1, 2021 10:29 | 0.10004 | 4.779777676 | 0.717255585 | 0.075777041 | 10.39372424 | 3.22056301 |
| May 1, 2021 10:30 | 0.1334 | 6.920063405 | 0.092574012 | 0.140366287 | 8.639970941 | 4.664319569 |
| May 1, 2021 10:31 | 0.10004 | 5.926016361 | 0.73948516 | 0.075552793 | 4.918942457 | 3.909368537 |
| May 1, 2021 10:32 | 2.262 | 17.85747186 | 42.07284203 | 4.267971286 | 12.00145627 | 11.84737136 |
| May 1, 2021 10:33 | 0.1167 | 3.287638534 | 0.201558638 | 0.099721789 | 1.167900746 | 1.878683196 |
| May 1, 2021 10:34 | 0.1667 | 3.417713577 | 0.018608799 | 0.195492987 | 1.17867732 | 1.950684447 |
| May 1, 2021 10:35 | 0.10004 | 1.741930504 | 0.262818556 | 0.067474335 | 0.547569083 | 0.931821966 |
| May 1, 2021 10:36 | 0.1333 | −0.714946337 | 0.137459832 | 0.1312249 | 0.336559696 | 0.552685523 |
| May 1, 2021 10:37 | 0.11676 | 0.308510674 | 0.200372242 | 0.099369253 | 0.026178422 | 0.066047144 |
| May 1, 2021 10:38 | 0.1667 | 0.046904147 | 0.016603829 | 0.195320592 | 0.073929852 | 0.092138203 |
| May 1, 2021 10:39 | 0.05002 | −0.545614715 | 0.434724204 | 0.029253012 | 0.287965901 | 0.450503639 |
| May 1, 2021 10:40 | 0.03336 | −0.187486516 | 0.488222623 | 0.061289289 | 0.163226941 | 0.233299145 |
| May 1, 2021 10:41 | 0.1667 | −0.415976323 | 0.002450751 | 0.195607818 | 0.249002198 | 0.371518068 |
| May 1, 2021 10:42 | 0.0834 | −0.829267811 | 0.302170318 | 0.03479117 | 0.399352365 | 0.621714047 |
| May 1, 2021 10:43 | 0.1 | −0.616915826 | 0.23813486 | 0.066779497 | 0.324815654 | 0.492260639 |
| May 1, 2021 10:44 | 0.1167 | 0.067958349 | 0.178924397 | 0.099003188 | 0.082311943 | 0.076191839 |
| May 1, 2021 10:45 | 0.1334 | −0.919385384 | 0.116623736 | 0.131226252 | 0.439133251 | 0.675732607 |
| May 1, 2021 10:46 | 0.15 | 1.623662423 | 0.059853097 | 0.163212138 | 0.467407274 | 0.87003766 |
| May 1, 2021 10:47 | 0.1167 | 2.536808648 | 0.185210411 | 0.09861966 | 0.778454729 | 1.423736402 |
| May 1, 2021 10:48 | 0.0834 | 2.336985625 | 0.301396079 | 0.03403054 | 0.685857369 | 1.299089533 |
| May 1, 2021 10:49 | 2.014 | 9.044064752 | 6.66292639 | 3.77363149 | 3.03936346 | 5.366642213 |
| May 1, 2021 10:50 | 0.25 | 0.816966948 | 0.14210514 | 0.347492958 | 0.064856361 | 0.358146481 |
| May 1, 2021 10:51 | 0.1334 | 1.839887715 | 0.180979859 | 0.123455971 | 0.39467786 | 0.966166092 |
| May 1, 2021 10:52 | 0.2001 | 0.799757605 | 0.001216301 | 0.251373636 | 0.035640218 | 0.346137858 |
| May 1, 2021 10:53 | 0.1167 | −0.8887198 | 0.226927423 | 0.090919431 | 0.533038132 | 0.659024909 |
| May 1, 2021 10:54 | 0.10004 | −0.230206122 | 0.271076197 | 0.058798571 | 0.314481293 | 0.266230366 |
| May 1, 2021 10:55 | 0.03333 | −0.861869615 | 0.450889848 | 0.069664611 | 0.528791075 | 0.64236537 |
| May 1, 2021 10:56 | 0.0834 | −0.796841182 | 0.303969836 | 0.026804891 | 0.505097697 | 0.602911698 |
| May 1, 2021 10:57 | 0.10004 | −0.856280215 | 0.257518013 | 0.058908424 | 0.525467975 | 0.637733657 |
| May 1, 2021 10:58 | 0.1833 | −0.733665283 | 0.030140554 | 0.219605027 | 0.483881454 | 0.563895327 |
| May 1, 2021 10:59 | 0.15 | −0.984464754 | 0.127673416 | 0.155087215 | 0.568175166 | 0.713045411 |
| May 1, 2021 10:00 | 0.0667 | −0.652618057 | 0.319114765 | 0.01808973 | 0.361011338 | 0.552306463 |

The health scores 1-3 of the servers 1-4 and the heat map data 3-39 is provided to an operating console computer 3-30 for inspection by a telco person 3-40 (a human being).

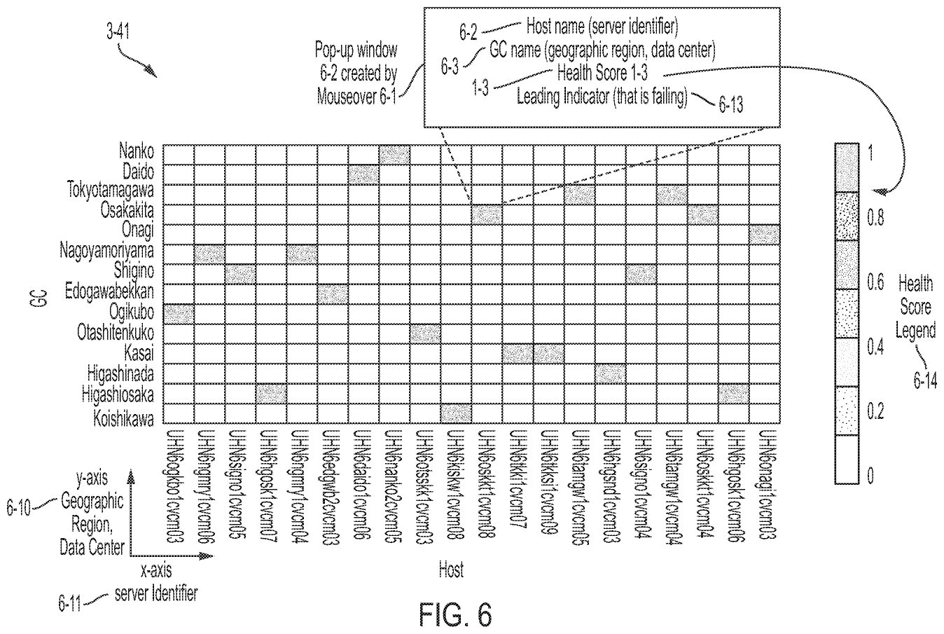

The heat map data 3-39 is presented on a display screen to the telco person 3-40 as a heat map 3-41 (a visual representation, see for example FIG. 6).

The telco person 3-40 may elicit further visual information by moving a pointing device such as a computer mouse near or over a visual cell or square corresponding to a particular server. The heat-map then provides a pop-window presenting additional data on that server.

A high score is like a high temperature, it is a symptom that the server will be substantially sick in the future. Based on a high score, the operating console computer 3-30 may automatically or at the direction of the telco person 3-40 (shown generally as input 3-42) send a confirmation request 3-31 (a query) to the cloud management server 2-2. The purpose of the query is to run diagnostics on the server in question. There is a cost to sending the query, so the thresholds to trigger a query are adjusted based on the cost of the query and the cost of the server ceasing to function without shift 4-60 moving virtual machines (VMs) away from the at-risk server. In some instances, shift 4-60 is a remedial load shift without which the at-risk server would cease to function. The remedial load shift moves VMs away from the at-risk server.

The cloud management server 2-2 may respond with a confirmation 3-32 indicating that the server is indeed at risk, or that the health score is a coincidence and there is nothing wrong with the server.

If the confirmation 3-32 is unable to establish that the server is healthy or indicates the server has additional indications of unreliability, action 3-33 may occur either automatically or at the direction of the telco person 3-40 (shown generally as input 3-42).

The action 3-33 may cause a shift 4-60 in the cloud of servers 1-5 as shown in FIG. 4C.

FIG. 3B illustrates the cloud of servers 1-5 including, among many servers, server K, server L and server 1-8. Internal representative hardware of a server K is illustrated. Server K is exemplary of the other servers of the server cloud 1-5. The server K includes CPU 3-79 which includes core 3-80, core 3-81 and other cores. Each core of CPU 3-79 can perform operations separately from the other cores. Or, multiple cores of CPU 3-79 may work together to perform parallel operations on a shared set of data in the CPU's memory cache (e.g., a portion of memory 3-76). The server K may have, for example, 80 cores. Server K is exemplary. Server K also includes one or more fans 3-78 which provide airflow, FPGA chips 3-77, and interrupt hardware 3-75. Example server parameters for the hardware components of server K are listed in Table 3, as follows.

TABLE 3
Example of 535 Server Parameters

| | |
|---|---|
| 1. | kernel_context_switches |
| 2. | kernel_boot_time |
| 3. | kernel_interrupts |
| 4. | kernel_processes_forked |
| 5. | kernel_entropy_avail |
| 6. | process_resident_memory_bytes |
| 7. | process_cpu_seconds_total |
| 8. | process_start_time_seconds |
| 9. | process_max_fds |
| 10. | process_virtual_memory_bytes |
| 11. | process_virtual_memory_max_bytes |
| 12. | process_open_fds |
| 13. | ceph_usage_total_used |
| 14. | ceph_usage_total_space |
| 15. | ceph_usage_total_avail |
| 16. | ceph_pool_usage_objects |
| 17. | ceph_pool_usage_kb_used |
| 18. | ceph_pool_usage_bytes_used |
| 19. | ceph_pool_stats_write_bytes_sec |
| 20. | ceph_pool_stats_recovering_objects_per_sec |
| 21. | ceph_pool_stats_recovering_keys_per_sec |
| 22. | ceph_pool_stats_recovering_bytes_per_sec |
| 23. | ceph_pool_stats_read_bytes_sec |
| 24. | ceph_pool_stats_op_per_sec |
| 25. | ceph_pgmap_write_bytes_sec |
| 26. | ceph_pgmap_version |
| 27. | ceph_pgmap_state_count |
| 28. | ceph_pgmap_read_bytes_sec |
| 29. | ceph_pgmap_op_per_sec |
| 30. | ceph_pgmap_num_pgs |
| 31. | ceph_pgmap_data_bytes |
| 32. | ceph_pgmap_bytes_used |
| 33. | ceph_pgmap_bytes_total |
| 34. | ceph_pgmap_bytes_avail |
| 35. | ceph_osdmap_num_up_osds |
| 36. | ceph_osdmap_num_remapped_pgs |
| 37. | ceph_osdmap_num_osds |
| 38. | ceph_osdmap_num_in_osds |
| 39. | ceph_osdmap_epoch |
| 40. | ceph_health |
| 41. | ceph_pool_stats_write_op_per_sec |
| 42. | ceph_pgmap_write_op_per_sec |
| 43. | ceph_pool_stats_read_op_per_sec |
| 44. | ceph_pgmap_read_op_per_sec |
| 45. | conntrack_ip_conntrack_max |
| 46. | conntrack_ip_conntrack_count |
| 47. | go_memstats_mcache_sys_bytes |
| 48. | go_memstats_buck_hash_sys_bytes |
| 49. | go_memstats_stack_sys_bytes |
| 50. | go_memstats_heap_objects |
| 51. | go_gc_duration_seconds_sum |
| 52. | go_memstats_heap_idle_bytes |
| 53. | go_memstats_heap_released_bytes_total |
| 54. | go_memstats_other_sys_bytes |
| 55. | go_memstats_heap_sys_bytes |
| 56. | go_memstats_mcache_inuse_bytes |
| 57. | go_memstats_mspan_inuse_bytes |
| 58. | go_memstats_heap_inuse_bytes |
| 59. | go_memstats_stack_inuse_bytes |
| 60. | go_gc_duration_seconds |
| 61. | go_memstats_alloc_bytes |
| 62. | go_gc_duration_seconds_count |
| 63. | go_memstats_alloc_bytes_total |
| 64. | go_memstats_sys_bytes |
| 65. | go_memstats_heap_released_bytes |
| 66. | go_memstats_gc_cpu_fraction |
| 67. | go_memstats_gc_sys_bytes |
| 68. | go_memstats_mallocs_total |
| 69. | go_memstats_mspan_sys_bytes |
| 70. | go_memstats_lookups_total |
| 71. | go_memstats_next_gc_bytes |
| 72. | go_threads |
| 73. | go_memstats_last_gc_time_seconds |
| 74. | go_memstats_frees_total |
| 75. | go_goroutines |
| 76. | go_info |
| 77. | go_memstats_heap_alloc_bytes |
| 78. | cp_hypervisor_memory_mb_used |
| 79. | cp_hypervisor_running_vms |
| 80. | cp_hypervisor_up |
| 81. | cp_openstack_service_up |
| 82. | cp_hypervisor_memory_mb |
| 83. | cp_hypervisor_vcpus |
| 84. | cp_hypervisor_vcpus_used |
| 85. | disk_inodes_used |
| 86. | disk_total |
| 87. | disk_inodes_total |
| 88. | disk_free |
| 89. | disk_inodes_free |
| 90. | disk_used_percent |
| 91. | disk_used |
| 92. | ntpq_offset |
| 93. | ntpq_reach |
| 94. | ntpq_delay |
| 95. | ntpq_when |
| 96. | ntpq_jitter |
| 97. | ntpq_poll |
| 98. | system_load15 |
| 99. | system_n_cpus |
| 100. | system_uptime |
| 101. | system_n_users |
| 102. | system_load5 |
| 103. | system_load1 |
| 104. | scrape_samples_scraped |
| 105. | scrape_samples_post_metric_relabeling |
| 106. | scrape_duration_seconds |
| 107. | intemal_memstats_heap_objects |
| 108. | internal_memstats_mallocs |
| 109. | internal_write_metrics_added |
| 110. | internal_write_write_time_ns |
| 111. | intemal_memstats_heap_idle_bytes |
| 112. | internal_agent_metrics_written |
| 113. | internal_agent_metrics_gathered |
| 114. | intemal_memstats_heap_in_use_bytes |
| 115. | intemal_memstats_heap_sys_bytes |
| 116. | internal_memstats_heap_released_bytes |
| 117. | internal_gather_gather_time_ns |
| 118. | internal_write_buffer_limit |
| 119. | internal_agent_gather_errors |
| 120. | internal_memstats_frees |
| 121. | internal_agent_metrics_dropped |
| 122. | internal_write_metrics_dropped |
| 123. | internal_memstats_num_gc |
| 124. | internal_write_buffer_size |
| 125. | internal_gather_metrics_gathered |
| 126. | internal_memstats_alloc_bytes |
| 127. | internal_write_metrics_written |
| 128. | internal_write_metrics_filtered |
| 129. | internal_memstats_sys_bytes |
| 130. | internal_memstats_total_alloc_bytes |
| 131. | internal_memstats_pointer_lookups |
| 132. | intemal_memstats_heap_alloc_bytes |
| 133. | diskio_iops_in_progress |
| 134. | diskio_io_time |
| 135. | diskio_read_time |
| 136. | diskio_writes |
| 137. | diskio_weighted_io_time |
| 138. | diskio_write_time |
| 139. | diskio_reads |
| 140. | diskio_write_bytes |
| 141. | diskio_read_bytes |
| 142. | net_icmpmsg_intype3 |
| 143. | net_icmp_inaddrmaskreps |
| 144. | net_icmpmsg_intype0 |
| 145. | net_tcp_rtoalgorithm |
| 146. | net_icmpmsg_intype8 |
| 147. | net_packets_sent |
| 148. | net_udplite_inerrors |
| 149. | net_udplite_sndbuferrors |
| 150. | net_conntrack_dialer_conn_closed_total |
| 151. | net_tcp_estabresets |
| 152. | net_icmp_indestunreachs |
| 153. | net_icmp_outaddrmasks |
| 154. | net_err_out |
| 155. | net_icmp_intimestamps |
| 156. | net_icmp_inerrors |
| 157. | net_ip_fragfails |
| 158. | net_ip_outrequests |
| 159. | net_udplite_rcvbuferrors |
| 160. | net_ip_inaddrerrors |
| 161. | net_tcp_insegs |
| 162. | net_tcp_incsumerrors |
| 163. | net_icmpmsg_outtype0 |
| 164. | net_icmpmsg_outtype3 |
| 165. | net_icmpmsg_outtype8 |
| 166. | net_icmp_intimestampreps |
| 167. | net_tcp_outsegs |
| 168. | net_ip_fragcreates |
| 169. | net_tcp_retranssegs |
| 170. | net_icmp_inechoreps |
| 171. | net_udplite_indatagrams |
| 172. | net_icmp_outtimestamps |
| 173. | net_ip_reasmoks |
| 174. | net_tcp_attemptfails |
| 175. | net_icmp_inmsgs |
| 176. | net_ip_reasmfails |
| 177. | net_ip_indelivers |
| 178. | net_icmp_intimeexeds |
| 179. | net_icmp_outredirects |
| 180. | net_ip_defaultttl |
| 181. | net_icmp_outtimeexeds |
| 182. | net_icmp_outechos |
| 183. | net_ip_forwarding |
| 184. | net_icmp_inechos |
| 185. | net_ip_indiscards |
| 186. | net_ip_reasmtimeout |
| 187. | net_udp_indatagrams |
| 188. | net_bytes_recv |
| 189. | net_icmp_outerrors |
| 190. | net_conntrack_listener_conn_accepted_total |
| 191. | net_icmp_inaddrmasks |
| 192. | net_err_in |
| 193. | net_tcp_passiveopens |
| 194. | net_icmp_outaddrmaskreps |
| 195. | net_udplite_incsumerrors |
| 196. | net_udp_noports |
| 197. | net_tcp_outrsts |
| 198. | net_drop_out |
| 199. | net_conntrack_dialer_conn_attempted_total |
| 200. | net_icmp_inparmprobs |
| 201. | net_icmp_insrcquenchs |
| 202. | net_drop_in |
| 203. | net_icmp_outtimestampreps |
| 204. | net_ip_inreceives |
| 205. | net_udplite_outdatagrams |
| 206. | net_ip_forwdatagrams |
| 207. | net_conntrack_listener_conn_closed_total |
| 208. | net_icmp_outsrcquenchs |
| 209. | net_icmp_outechoreps |
| 210. | net_tcp_rtomax |
| 211. | net_udp_rcvbuferrors |
| 212. | net_conntrack_dialer_conn_established_total |
| 213. | net_tcp_activeopens |
| 214. | net_ip_outnoroutes |
| 215. | net_tcp_currestab |
| 216. | net_ip_outdiscards |
| 217. | net_tcp_maxconn |
| 218. | net_udp_inerrors |
| 219. | net_tcp_rtomin |
| 220. | net_icmp_inredirects |
| 221. | net_icmp_outmsgs |
| 222. | net_icmp_outparmprobs |
| 223. | net_ip_reasmreqds |
| 224. | net_ip_inunknownprotos |
| 225. | net_udplite_noports |
| 226. | net_icmp_inesumerrors |
| 227. | net_ip_inhdrerrors |
| 228. | net_udp_incsumerrors |
| 229. | net_packets_recv |
| 230. | net_conntrack_dialer_conn_failed_total |
| 231. | net_bytes_sent |
| 232. | net_udp_sndbuferrors |
| 233. | net_udp_outdatagrams |
| 234. | net_tcp_inerrs |
| 235. | net_ip_fragoks |
| 236. | net_icmp_outdestunreachs |
| 237. | swap_out |
| 238. | swap_used |
| 239. | swap_free |
| 240. | swap_total |
| 241. | swap_in |
| 242. | swap_used_percent |
| 243. | http_response_result_code |
| 244. | http_response_http_response_code |
| 245. | http_response_response_time |
| 246. | mem_available_percent |
| 247. | mem_huge_pages_total |
| 248. | mem_used |
| 249. | mem_total |
| 250. | mem_commit_limit |
| 251. | mem_available |
| 252. | mem_cached |
| 253. | mem_write_back |
| 254. | mem_dirty |
| 255. | mem_used_percent |
| 256. | mem_vmalloc_chunk |
| 257. | mem_page_tables |
| 258. | mem_high_free |
| 259. | mem_swap_free |
| 260. | mem_swap_total |
| 261. | mem_committed_as |
| 262. | mem_inactive |
| 263. | mem_low_total |
| 264. | mem_buffered |
| 265. | mem_huge_pages_free |
| 266. | mem_swap_cached |
| 267. | mem_vmalloc_total |
| 268. | mem_slab |
| 269. | mem_vmalloc_used |
| 270. | mem_wired |
| 271. | mem_high_total |
| 272. | mem_shared |
| 273. | mem_free |
| 274. | mem_write_back_tmp |
| 275. | mem_mapped |
| 276. | mem_huge_page_size |
| 277. | mem_low_free |
| 278. | mem_active |
| 279. | ipmi_sensor |
| 280. | ipmi_sensor_status |
| 281. | linkstate_partner |
| 282. | linkstate_actor |
| 283. | linkstate_sriov |
| 284. | prometheus_sd_kubernetes_cache_short_watches_total |
| 285. | prometheus_engine_query_duration_seconds_count |
| 286. | prometheus_tsdb_reloads_total |
| 287. | prometheus_template_text_expansion_failures_total |
| 288. | prometheus_target_scrape_pool_sync_total |
| 289. | prometheus_rule_group_duration_seconds_sum |
| 290. | prometheus_tsdb_checkpoint_deletions_total |
| 291. | prometheus_sd_openstack_refresh_failures_total |
| 292. | prometheus_target_interval_length_seconds_sum |
| 293. | prometheus_sd_gce_refresh_duration_count |
| 294. | prometheus_tsdb_compaction_chunk_size_bytes_count |
| 295. | prometheus_notifications_sent_total |
| 296. | prometheus_sd_consul_rpc_duration_seconds_sum |
| 297. | prometheus_http_request_duration_seconds_bucket |
| 298. | prometheus_tsdb_compaction_duration_seconds_bucket |
| 299. | prometheus_sd_ec2_refresh_duration_seconds_count |
| 300. | prometheus_sd_kubernetes_cache_list_duration_seconds_sum |
| 301. | prometheus_sd_dns_lookups_total |
| 302. | prometheus_template_text_expansions_total |
| 303. | prometheus_sd_triton_refresh_duration_seconds_sum |
| 304. | prometheus_sd_ec2_refresh_failures_total |
| 305. | prometheus_rule_group_duration_seconds |
| 306. | prometheus_sd_triton_refresh_failures_total |
| 307. | prometheus_sd_kubernetes_cache_list_items_count |
| 308. | prometheus_sd_kubernetes_events_total |
| 309. | prometheus_sd_file_scan_duration_seconds |
| 310. | prometheus_tsdb_wal_tmncate_duration_seconds_sum |
| 311. | prometheus_sd_dns_lookup_failures_total |
| 312. | prometheus_engine_query_duration_seconds_sum |
| 313. | prometheus_sd_openstack_refresh_duration_seconds |
| 314. | prometheus_tsdb_head_max_time_seconds |
| 315. | prometheus_rule_evaluation_duration_seconds |
| 316. | prometheus_tsdb_head_series_created_total |
| 317. | prometheus_tsdb_head_truncations_total |
| 318. | prometheus_tsdb_checkpoint_creations_total |
| 319. | prometheus_tsdb_head_gc_duration_seconds_sum |
| 320. | prometheus_tsdb_head_chunks_removed_total |
| 321. | prometheus_sd_azure_refresh_failures_total |
| 322. | prometheus_http_response_size_bytes_sum |
| 323. | prometheus_sd_triton_refresh_duration_seconds |
| 324. | prometheus_tsdb_head_series_removed_total |
| 325. | prometheus_rule_group_interval_seconds |
| 326. | prometheus_notifications_latency_seconds_count |
| 327. | prometheus_http_request_duration_seconds_sum |
| 328. | prometheus_http_request_duration_seconds_count |
| 329. | prometheus_tsdb_tombstone_cleanup_seconds_count |
| 330. | prometheus_tsdb_compaction_chunk_range_seconds_sum |
| 331. | prometheus_tsdb_wal_fsync_duration_seconds |
| 332. | prometheus_target_sync_length_seconds_count |
| 333. | prometheus_sd_consul_rpc_duration_seconds_count |
| 334. | prometheus_tsdb_compaction_chunk_range_seconds_count |
| 335. | prometheus_sd_marathon_refresh_duration_seconds_sum |
| 336. | prometheus_tsdb_compactions_total |
| 337. | prometheus_target_sync_length_seconds |
| 338. | prometheus_tsdb_wal_fsync_duration_seconds_count |
| 339. | prometheus_sd_marathon_refresh_duration_seconds |
| 340. | prometheus_treecache_watcher_goroutines |
| 341. | prometheus_sd_updates_total |
| 342. | prometheus_tsdb_compaction_chunk_samples_bucket |
| 343. | prometheus_sd_openstack_refresh_duration_seconds_sum |
| 344. | prometheus_target_scrapes_sample_out_of_bounds_total |
| 345. | prometheus_tsdb_time_retentions_total |
| 346. | prometheus_notifications_queue_capacity |
| 347. | prometheus_tsdb_head_truncations_failed_total |
| 348. | prometheus_tsdb_wal_page_flushes_total |
| 349. | prometheus_sd_kubernetes_cache_list_items_sum |
| 350. | prometheus_sd_kubernetes_cache_last_resource_version |
| 351. | prometheus_http_response_size_bytes_bucket |
| 352. | prometheus_target_sync_length_seconds_sum |
| 353. | prometheus_tsdb_wal_corruptions_total |
| 354. | prometheus_notifications_alertmanagers_discovered |
| 355. | prometheus_rule_group_last_evaluation_timestamp_seconds |
| 356. | prometheus_sd_azure_refresh_duration_seconds |
| 357. | prometheus_sd_gce_refresh_duration |
| 358. | prometheus_notifications_latency_seconds_sum |
| 359. | prometheus_sd_gce_refresh_failures_total |
| 360. | prometheus_tsdb_compactions_triggered_total |
| 361. | prometheus_sd_azure_refresh_duration_seconds_count |
| 362. | prometheus_rule_evaluations_total |
| 363. | prometheus_rule_group_last_duration_seconds |
| 364. | prometheus_tsdb_wal_fsync_duration_seconds_sum |
| 365. | prometheus_target_interval_length_seconds |
| 366. | prometheus_tsdb_wal_completed_pages_total |
| 367. | prometheus_tsdb_head_max_time |
| 368. | prometheus_tsdb_checkpoint_creations_failed_total |
| 369. | prometheus_treecache_zookeeper_failures_total |
| 370. | prometheus_sd_marathon_refresh_failures_total |
| 371. | prometheus_tsdb_wal_truncations_total |
| 372. | prometheus_sd_openstack_refresh_duration_seconds_count |
| 373. | prometheus_tsdb_head_series_not_found_total |
| 374. | prometheus_tsdb_lowest_time_stamp |
| 375. | prometheus_tsdb_compaction_chunk_size_bytes_bucket |
| 376. | prometheus_sd_kubernetes_cache_list_duration_seconds_count |
| 377. | prometheus_tsdb_head_active_appenders |
| 378. | prometheus_tsdb_wal_truncations_failed_total |
| 379. | prometheus_tsdb_compactions_failed_total |
| 380. | prometheus_sd_kubernetes_cache_watch_events_count |
| 381. | prometheus_rule_evaluation_duration_seconds_sum |
| 382. | prometheus_tsdb_compaction_chunk_samples_sum |
| 383. | prometheus_sd_consul_rpc_failures_total |
| 384. | prometheus_tsdb_storage_blocks_bytes_total |
| 385. | prometheus_sd_kubernetes_cache_watches_total |
| 386. | prometheus_tsdb_checkpoint_deletions_failed_total |
| 387. | prometheus_sd_ec2_refresh_duration_seconds_sum |
| 388. | prometheus_rule_group_rules |
| 389. | prometheus_notifications_errors_total |
| 390. | prometheus_sd_file_scan_duration_seconds_count |
| 391. | prometheus_tsdb_head_min_time_seconds |
| 392. | prometheus_tsdb_compaction_duration_seconds_count |
| 393. | prometheus_rule_group_iterations_total |
| 394. | prometheus_sd_ec2_refresh_duration_seconds |
| 395. | prometheus_engine_queries_concurrent_max |
| 396. | prometheus_engine_queries |
| 397. | prometheus_tsdb_wal_truncate_duration_seconds |
| 398. | prometheus_engine_query_duration_seconds |
| 399. | prometheus_tsdb_lowest_timestamp_seconds |
| 400. | prometheus_notifications_dropped_total |
| 401. | prometheus_sd_kubernetes_cache_watch_duration_seconds_count |
| 402. | prometheus_tsdb_compaction_chunk_samples_count |
| 403. | prometheus_sd_consul_rpc_duration_seconds |
| 404. | prometheus_rule_evaluation_failures_total |
| 405. | prometheus_sd_file_read_errors_total |
| 406. | prometheus_tsdb_head_chunks_created_total |
| 407. | prometheus_rule_group_iterations_missed_total |
| 408. | prometheus_tsdb_head_min_time |
| 409. | prometheus_tsdb_tombstone_cleanup_seconds_sum |
| 410. | prometheus_rule_evaluation_duration_seconds_count |
| 411. | prometheus_target_scrapes_sample_out_of_order_total |
| 412. | prometheus_notifications_queue_length |
| 413. | prometheus_tsdb_blocks_loaded |
| 414. | prometheus_tsdb_head_gc_duration_seconds_count |
| 415. | prometheus_sd_kubernetes_cache_list_total |
| 416. | prometheus_sd_discovered_targets |
| 417. | prometheus_target_scrapes_sample_duplicate_timestamp_total |
| 418. | prometheus_config_last_reload_success_timestamp_seconds |
| 419. | prometheus_sd_marathon_refresh_duration_seconds_count |
| 420. | prometheus_sd_triton_refresh_duration_seconds_count |
| 421. | prometheus_http_response_size_bytes_count |
| 422. | prometheus_notifications_latency_seconds |
| 423. | prometheus_config_last_reload_successful |
| 424. | prometheus_tsdb_head_series |
| 425. | prometheus_tsdb_compaction_chunk_size_bytes_sum |
| 426. | prometheus_tsdb_head_samples_appended_total |
| 427. | prometheus_api_remote_read_queries |
| 428. | prometheus_sd_gce_refresh_duration_sum |
| 429. | prometheus_rule_group_duration_seconds_count |
| 430. | prometheus_sd_kubernetes_cache_watch_events_sum |
| 431. | prometheus_sd_file_scan_duration_seconds_sum |
| 432. | prometheus_target_scrapes_exceeded_sample_limit_total |
| 433. | prometheus_tsdb_head_gc_duration_seconds |
| 434. | prometheus_build_info |
| 435. | prometheus_tsdb_compaction_duration_seconds_sum |
| 436. | prometheus_tsdb_size_retentions_total |
| 437. | prometheus_sd_azure_refresh_duration_seconds_sum |
| 438. | prometheus_tsdb_compaction_chunk_range_seconds_bucket |
| 439. | prometheus_tsdb_wal_truncate_duration_seconds_count |
| 440. | prometheus_target_interval_length_seconds_count |
| 441. | prometheus_tsdb_tombstone_cleanup_seconds_bucket |
| 442. | prometheus_tsdb_head_chunks |
| 443. | prometheus_sd_received_updates_total |
| 444. | prometheus_tsdb_reloads_failures_total |
| 445. | prometheus_tsdb_symbol_table_size_bytes |
| 446. | prometheus_sd_kubernetes_cache_watch_duration_seconds_sum |
| 447. | haproxy_req_rate_max |
| 448. | haproxy_chkdown |
| 449. | haproxy_wredis |
| 450. | haproxy_chkfail |
| 451. | haproxy_active_servers |
| 452. | haproxy_econ |
| 453. | haproxy_qmax |
| 454. | haproxy_check_code |
| 455. | haproxy_lastsess |
| 456. | haproxy_bin |
| 457. | haproxy_downtime |
| 458. | haproxy_http_response_1xx |
| 459. | haproxy_backup_servers |
| 460. | haproxy_req_rate |
| 461. | haproxy_req_tot |
| 462. | haproxy_http_response_4xx |
| 463. | haproxy_qcur |
| 464. | haproxy_iid |
| 465. | haproxy_weight |
| 466. | haproxy_smax |
| 467. | haproxy_rate_max |
| 468. | haproxy_hanafail |
| 469. | haproxy_srv_abort |
| 470. | haproxy_wretr |
| 471. | haproxy_lastchg |
| 472. | haproxy_eresp |
| 473. | haproxy_stot |
| 474. | haproxy_dresp |
| 475. | haproxy_sid |
| 476. | haproxy_qtime |
| 477. | haproxy_comp_rsp |
| 478. | haproxy_dreq |
| 479. | haproxy_rate_lim |
| 480. | haproxy_cli_abort |
| 481. | haproxy_scur |
| 482. | haproxy_http_response_5xx |
| 483. | haproxy_comp_in |
| 484. | haproxy_rate |
| 485. | haproxy_ereq |
| 486. | haproxy_rtime |
| 487. | haproxy_lbtot |
| 488. | haproxy_ttime |
| 489. | haproxy_pid |
| 490. | haproxy_comp_out |
| 491. | haproxy_http_response_3xx |
| 492. | haproxy_ctime |
| 493. | haproxy_bout |
| 494. | haproxy_http_response_2xx |
| 495. | haproxy_slim |
| 496. | haproxy_check_duration |
| 497. | haproxy_http_response_other |
| 498. | haproxy_comp_byp |
| 499. | processes_sleeping |
| 500. | processes_paging |
| 501. | processes_unknown |
| 502. | processes_stopped |
| 503. | processes_total_threads |
| 504. | processes_running |
| 505. | processes_total |
| 506. | processes_zombies |
| 507. | processes_blocked |
| 508. | processes_idle |
| 509. | processes_dead |
| 510. | promhttp_metric_handler_requests_total |
| 511. | promhttp_metric_handler_requests_in_flight |
| 512. | up |
| 513. | hugepages_free |
| 514. | hugepages_surplus |
| 515. | hugepages_nr |
| 516. | docker_container_mem_usage |
| 517. | docker_container_mem_usage_percent |
| 518. | docker_container_status_finished_at |
| 519. | docker_n_containers_stopped |
| 520. | docker_container_status_exitcode |
| 521. | docker_container_cpu_usage_percent |
| 522. | docker_n_containers |
| 523. | docker_n_containers_paused |
| 524. | docker_n_containers_running |
| 525. | docker_container_status_started_at |
| 526. | cpu_usage_softirq |
| 527. | cpu_usage_guest |
| 528. | cpu_usage_guest_nice |
| 529. | cpu_usage_idle |
| 530. | cpu_usage_iowait |
| 531. | cpu_usage_steal |
| 532. | cpu_usage_nice |
| 533. | cpu_usage_user |
| 534. | cpu_usage_irq |
| 535. | cpu_usage_system |

FIG. 3C illustrates exemplary illustration of the flow 3-13, in terms of matrices, according to some embodiments. Parameters for each core of server K are shown as 3-83 and 3-84. Parameters common to the cores are shown as 3-85 (for example, memory 3-76).

Table 4 illustrates an exemplary representation of a matrix from which the decision trees are built.

| | Example Statistic Types | | | |
|---|---|---|---|---|
| Example | | Standard | | |
| Server | Running | deviation | | Spectral |
| Parameters | average | (sigma) | Z score | residual |
| FPGA | (indexed by | (indexed | (indexed by | (indexed by |
| | server and | by server | server and | server and |
| | time) | and time) | time) | time) |
| CPU load | (indexed by | (indexed | (indexed by | (indexed by |
| processes | server, core, | by server, | server, core, | server, core, |
| | and time) | core, and | and time) | and time) |
| | | time) | | |
| Airflow | (indexed by | (indexed | (indexed by | (indexed by |
| (fans) | server and | by server | server and | server and |
| | time) | and time) | time) | time) |
| Memory | (indexed by | (indexed | (indexed by | (indexed by |
| | server and | by server | server and | server and |
| | time) | and time) | time) | time) |
| Interrupt | (indexed by | (indexed | (indexed by | (indexed by |
| | server and | by server | server and | server and |
| | time) | and time) | time) | time) |

FIG. 4A illustrates a telco core network 4-20 using the cloud of servers 1-5 and providing service to telco radio network 4-21 in a system 4-9.

Example servers K, L, and 1-8 are shown in FIG. 4A. The number of servers in FIG. 4A is 1,000 or more (up to 6,000). VM11 and VM12 (virtual machines) are example virtual machines running on server K. VM21 and VM22 are example virtual machines running on server L. VM31 and VM32 are example virtual machines running on server 1-8.

Each server of the servers 1-4 may provide network slices, backup equipment, network interfaces, processing resources and memory resources for use by software modules which implement the telco core network 4-20. Servers 1-4 in cloud of servers 1-5 is indicated in FIG. 2. A partial list of examples of software modules are firewalls, load balancers and gateways. A combination of software modules is a virtual machine which runs on the resources provided by a given server.

If a given server is at risk, the software (corresponding to the virtual machine) may be swapped or moved to run on resources of another server. In this fashion, server computer hardware can be used to perform many different virtual machines, and with short notice. Examples of server computer hardware are servers provided by the computer-assembly companies Quanta Services (“Quanta” of Houston, Tex.) and Supermicro (San Jose, Calif.). For example, Quanta may buy Intel hardware (Intel of Santa Clara, Calif.) and assemble it in a Quanta facility. Quanta may bring the assembled hardware to the customer site (telco operator site) and install it. Server computer hardware can also be based on computer chips from other chip vendors, such as for, example, AMD and NVIDIA (both of Santa Clara, Calif.).

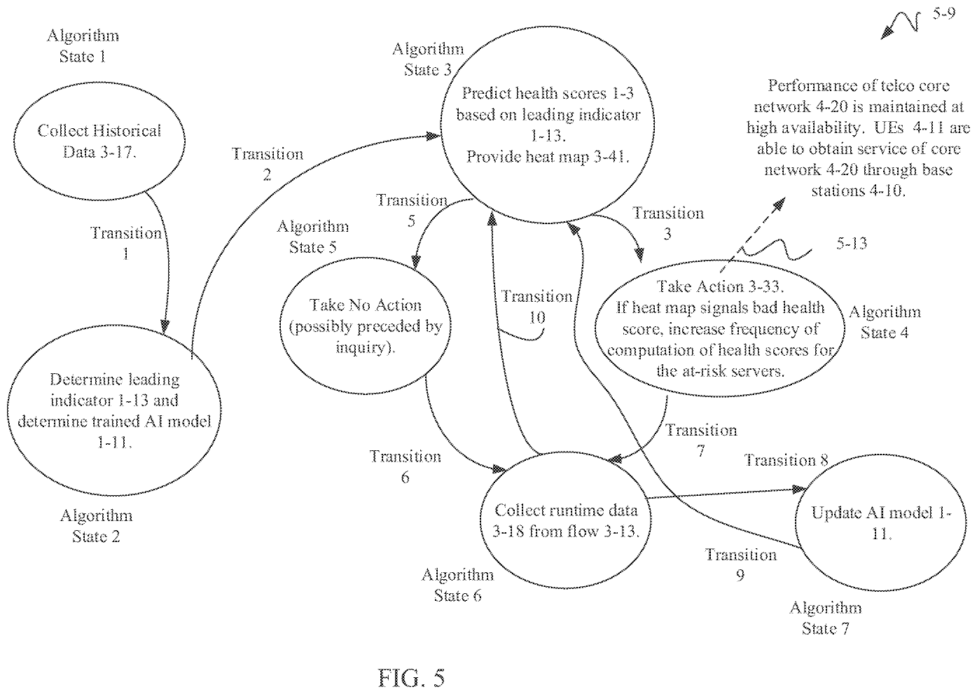

As mentioned above, the flow 3-13 may be on the order of 1,000,000 server parameters per minute. Some of the flow 3-13 is collected as runtime data (see FIG. 5 algorithm state 6). The purpose of collecting runtime data is to update the AI model 1-11 (see FIG. 5 algorithm state 7).

FIG. 4A also illustrates exemplary UE1 and UE2 which belong to an overall set of UEs 4-11. The number of UEs 4-11 may be in the millions.

The UEs 4-11 communicate over channels 4-12 with Base Stations 4-10. The number of Base Stations 4-10 may be on the order of 10,000. The UEs 4-11 and Base Stations 4-10 taken together are referred to herein as telco radio network 4-21. The cloud of servers 1-5, network connections 4-2 and cloud management server 2-2 taken together are referred to herein as telco core network 4-20. The network connections may be circuit or packet based.

If a VM, e.g., VM31 in server 1-8 of FIG. 4A, providing firewall service for a data flow reaching UE1 fails, then a user of UE1 suffers degraded service (lost or delayed data). Thus, a person using a UE is directly dependent on the virtual machines in the cloud of servers 1-5 having high availability (being there almost all the time, e.g., 99.9% or higher).

FIG. 4B illustrates further exemplary details of the system 4-9 including the telco operator control 2-1 interacting with the telco core network 4-20, according to some embodiments. In some embodiments, the telco core network 4-20 is implemented as an on-prem cloud. Similar to FIG. 3A, telco operator control 2-1 includes model building computer 3-10, AI inference engine 3-30, operating console computer 3-30 (which may be, for example, a laptop computer, a tablet computer, a desk computer, a computer providing video signals to a wall-sized display screen, or a smartphone). The telco person 3-40 is also indicated.

The flow 3-13 may arrive directly at 2-1 (connections 4-3 and 4-4) or via the cloud management server 2-2. Examples of data in the flow 3-13 are given in the columns labelled “cpu io wait” (second column) of each of Tables 1 and 2. Types of statistics are applied in the model builder computer 3-10. Examples of obtained statistics are shown in the second through sixth columns of Tables 1 and 2.

The model builder computer 3-10 configures decision trees by processing the server parameters using the various statistic types (see Table 4). For example, the model builder computer 3-10 may start with a single tree which attempts to predict hardware failure, using a decision referring to one server parameter. The model builder 3-10 may then investigate adding a second tree out of many possible second trees using an objective function. The addition of the second tree should both increase reliability of the prediction and control complexity of the model. Reliability is increased by using a loss term in the objective function and complexity is controlled by a regularization term. For more details of objective functions for configuring decision trees, see the above mentioned XGBoost Page.

Configuring the decision trees in this manner leads to an inference engine which is both accurate and scalable. Scalable, as one example, means that the inference engine is still fast even if a number of servers is in the thousands and then doubles, the parameters are in the hundreds and the evaluation needs to be repeated frequently.

FIG. 4C illustrates exemplary details of a shift 4-60 to move a load 4-61 to a low-risk server 4-62 (for example to server K and/or server L).

FIG. 4C is not concerned with model building, so the model builder computer is not shown. The flow 3-13 arrives at the AI inference engine 3-30 and heat map data 3-39 is produced and provided to the operating console computer 3-30. The heat map 3-41 is visually presented to the telco person 3-40. As discussed above in the discussion of FIG. 3, in some instances, there is a decision to move virtual machines away from an at-risk server, for example away from server 1-8. The VM31 and VM32 are referred to generally as a load 4-61. This shift may be also referred to as a load balancing or as a hot swap.

Based on the shift 4-60, problems with server 1-8 can be addressed without loss or delay of data to UEs 4-11. This reduces loss of data and this avoids delay in data flow; these are quantitative improvements, the flow of information over channels 4-12 is an electrical event (radio).

FIG. 5 illustrates an algorithm flow 5-9. At algorithm state 1, historical data 3-17 is collected. Transition 1 is then made to algorithm state 2. At algorithm state 2, leading indicator 1-13 is determined, and the trained AI model 1-11 is determined, using for example, xgboost (see FIG. 10). Via transition 2, the trained AI model 1-11 is distributed (e.g., pushed) to a computer 3-90 (which may be a server). The combination of the computer and the trained AI model as a component forms AI inference engine 3-20 of FIG. 3A. The flow 3-13 to the AI inference engine begins. In algorithm state 3, health scores 1-3 are predicted by the AI inference engine based on the leading indicator 1-13. At a suitable timing, heat map 3-41 is provided. From algorithm state 3, no action may be taken (in algorithm state 5 via transition 5) or action 3-33 may be taken (in algorithm state 4 via transition 3). Dashed arrow 5-13 indicates improvement to UEs 4-11 in that performance of telco core network 4-20 is maintained at high availability to UEs 4-11. After both of algorithm states 4 and 5, algorithm state 6 is reached (via transitions 7 and 6, respectively). In algorithm state 6, runtime data 3-18 is collected from flow 3-13. From algorithm state 6, via transition 10, the algorithm flow 5-9 generally proceeds back to algorithm state 3 and prediction of health scores 1-3. Health scores 1-3 are now based on the additional data collected at algorithm state 6.

Based on passage of time or accumulation of a threshold amount of data, the algorithm flow 5-9 may visit algorithm state 7 from algorithm state 6 via transition 8. At algorithm state 7 the trained AI model 1-11 is updated before returning to algorithm state 3 via transition 9. Transition 8 is performed on an as-needed basis to maintain accuracy of the trained AI model. For example, if the initial AI model 3-14 is based on six months of server data, the transition 8 may be made once a week and only small changes will occur in the updated AI model 3-16. Examples of changes to the server cloud 1-5 which affect AI inference are additional servers added to the server cloud 1-5, changes in protocols used by some servers and/or changes in traffic patterns, for example. Both initial AI model 3-14 and updated AI model 3-16 are versions of AI model 1-11.

FIG. 6 illustrates an exemplary heat map 3-41. In some embodiments, the heat map is a grid with a vertical direction corresponding to a list of regions (GC corresponds to a data center region, for example an east region or a west region, see y-axis 6-10 in FIG. 6) and a horizontal direction (indicated in FIG. 6 as x-axis 6-11) corresponding to a list of servers including a server illustrated as “Host” in FIG. 6. The health scores indicating at-risk servers are displayed in the heat map 3-41. The health scores of low-risk servers may be or may not be in the heat map 3-41. A server may be determined to be at-risk if the health score is above a threshold. The threshold may be configured based on detection probabilities such as probability of false alarm and probability of detection that a server is an at-risk server. A health score legend 6-14 indicates if the server is healthy (0 health score) or likely to fail (health score of 1.0). A mouseover by telco person 3-40 creates pop-up window 6-2. The pop-up window 6-2 displays additional information such as host name 6-2, GC name 6-3, health score 1-3, and the leading indicator 6-13 (that indicates, by a value of a leaf in a decision tree, prediction of failure). GC name corresponds to a data center and data centers correspond to geographic regions.

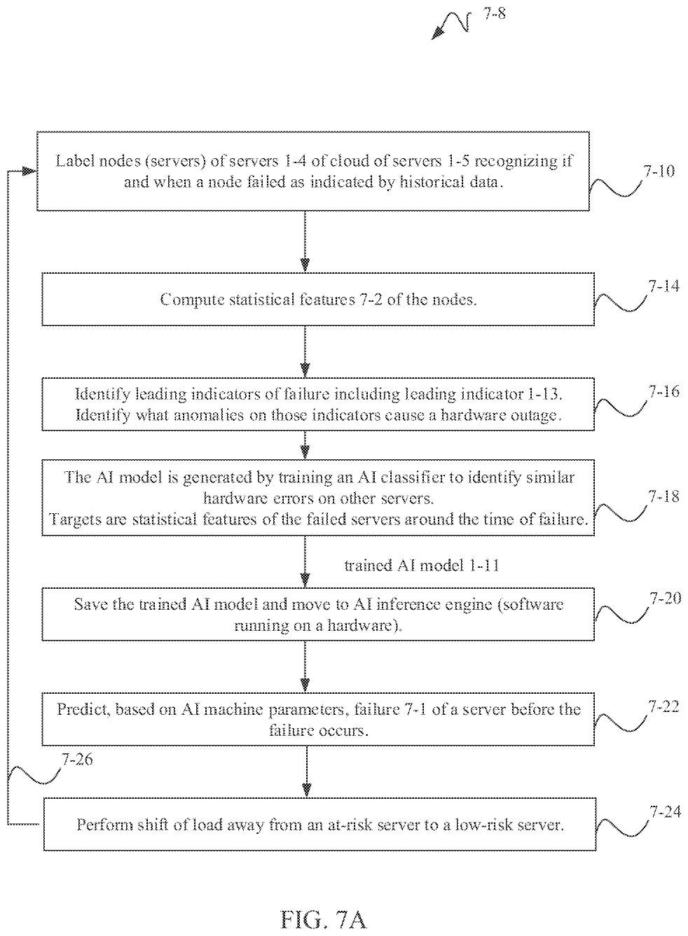

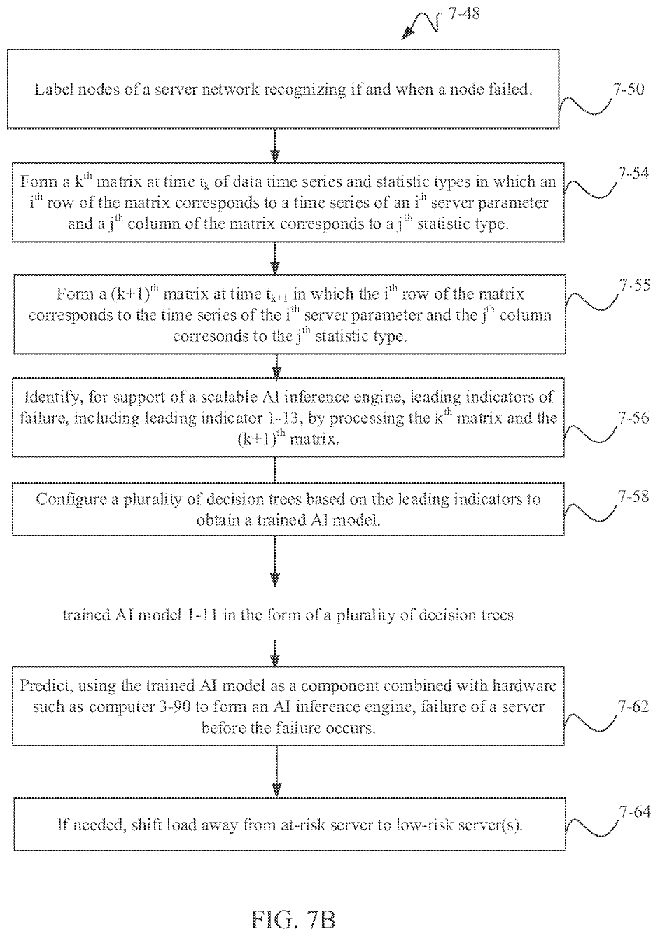

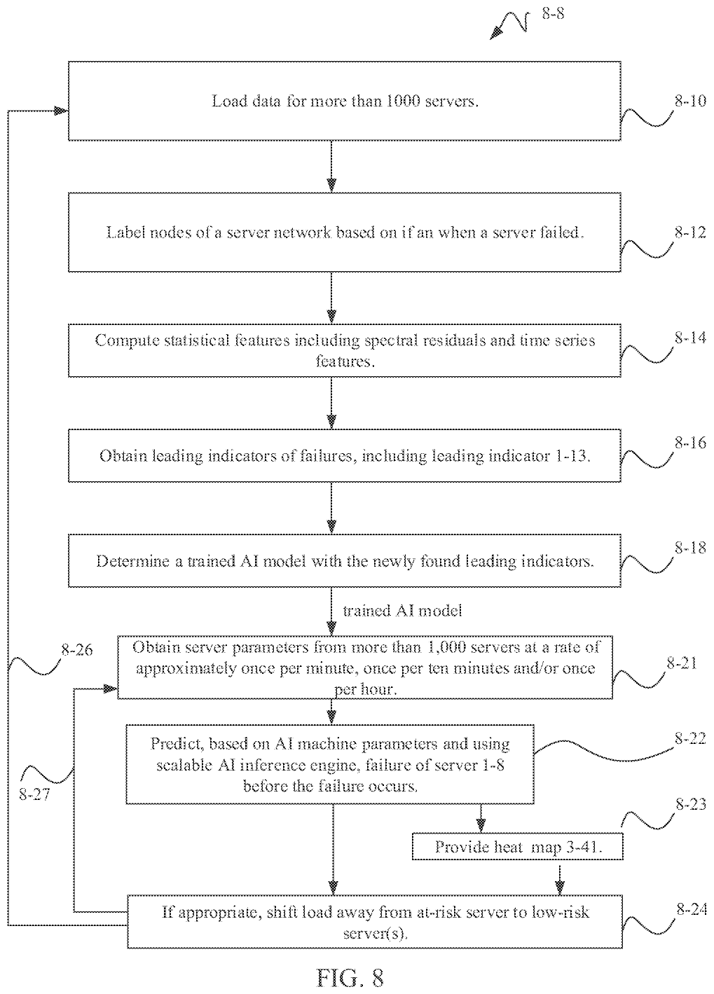

FIG. 7A illustrates exemplary logic 7-8 for prediction of a hardware failure of server 1-8 based on leading indicator 1-13 and performing a shift 4-60 to move the load away from an at-risk server to a low-risk server 4-62. As shown in FIG. 1, server 1-8 is a server of the servers 1-4. Operation 7-10 includes labelling nodes (servers) of servers 1-4 of cloud of servers 1-5 based on recognizing if and when a node failed as indicated by historical data.

Generally, a server hardware failure means that a server is unresponsive or has re-booted on its own. Labelling, in some embodiments, is based on recognizing these events in historical data (e.g., unresponsive server or unexpected re-boot of the server). Operation 7-10 labels nodes listed in the historical data as including a failure or not including a failure. If a node has had a failure, the labelling indicates the time that the node failed and captures server parameters of a few hours or days before the failure. The time of failure is, for example, defined as a small window around 1 to 15 minutes in width. At operation 7-14, statistical features 7-2 of the labelled nodes are computed. At operation 7-16, logic 7-8 identifies leading indicators of failure including leading indicator 1-13 using the statistical features 7-2, and, for example, using a supervised learning algorithm such as xgboost (see FIG. 10). At operation 7-18, logic 7-8 configures the AI inference engine 3-20 using the trained AI model 1-11. The trained AI model 1-11 is based on leading indicator 1-13.

At operation 7-22, logic 7-8 predicts, using the AI inference engine 3-20 which is based on the trained AI model 1-11, potential failure 7-1 of server 1-8 before the failure occurs. Also see the heat map 3-41 of FIG. 6 in which pop-up window 6-2 shows health score 1-3 and leading indicator (that is failing) 6-13.

At operation 7-24, in some instances depending on the result of the prediction and also whether telco person 3-40 gives shift instructions, logic 7-8 performs shift 4-60 of load 4-61 away from an at-risk server to a low-risk server (also see FIG. 4C and the related descriptions for more details regarding shift 4-60).

In some embodiments, at an appropriate time (e.g., 1-4 weeks), a new model is built as shown by the return path 7-26. Alternatively, an existing model may be incrementally adjusted by adding some decision trees and/or updating some decision trees of the trained AI model 1-11.

In some embodiments, the data passed to the tree-building algorithm of model builder computer 3-10 may be represented in a matrix form or another data structure.

FIG. 7B illustrates exemplary logic 7-48 for prediction of a hardware failure of a server. Exemplary logic 7-48 uses data structures and statistic types to identify one or more leading indicators for support of a scalable AI inference engine.

In FIG. 7B, at operation 7-50, logic 7-48 labels nodes of a server network recognizing if and when a node failed. At operation 7-54, logic 7-8 forms a k^{th} matrix at time tₖ of data time series and statistic types in which an i^{th} row of the matrix corresponds to a time series of an i^{th} server parameter and a j^{th} column of the matrix corresponds to a j^{th} statistic type.

At operation 7-55, logic 7-8 forms a (k+1)^{th} matrix at time tₖ₊₁ in which the i^{th} row of the matrix corresponds to the time series of the i^{th} server parameter and the j^{th} column corresponds to the j^{th} statistic type.

At operation 7-56, logic 7-8 identifies leading indicators of failure, including leading indicator 1-13, by processing the k^{th} matrix and the (k+1)^{th} matrix.

At operation 7-58, logic 7-8 configures a plurality of decision trees based on the leading indicators. The configuration of the plurality of decision trees is indicated by the trained AI model for a plurality of decision trees. This concludes operation of the model builder. The model builder may adaptively update the decision trees on an ongoing basis.

At operation 7-62, logic 7-8 predicts (if applicable), using the AI inference engine, potential failure of a server before the failure occurs.

At operation 7-64, if needed, logic 7-8 shifts load away from at-risk server to one or more low-risk servers.

FIG. 8 illustrates exemplary logic 8-8 for receiving data from more than 1000 servers, identifying leading indicator 1-13 using statistical features and predicting the failure of server 1-8 using an AI inference engine.

At operation 8-10, logic 8-8 loads data of more than 1000 servers. At operation 8-12, based on the loaded data, logic 8-8 labels nodes of a server network based on if and when a server failed. At operation 8-14, logic 8-8 computes statistical features including spectral residuals and time series features of those labelled servers which failed and of those servers which did not fail. At operation 8-16, logic 8-8 obtains leading indicators of failures using the statistical features (see FIG. 10 and description). At operation 8-18, logic 8-8 determines the trained AI model with the newly found leading indicators. This concludes the model builder work to generate a model.

At operation 8-21, logic 8-8 obtains server parameters from more than 1,000 servers at a rate configured to track evolution of the system. The rate may be once per minute or once per ten minutes for an already-identified at-risk server. The rate may be once per hour for monitoring each and every server in the cloud of servers 1-5. At operation 8-22, logic 8-8 predicts, based on the server parameters obtained in operation 8-21 and based on the trained AI model from 8-18 (which enables a scalable AI inference engine), potential failure of server 1-8 before the failure occurs. In some embodiments, a heat map is then provided (in operation 8-23).

At operation 8-24, if appropriate, logic 8-8 shifts load away from at-risk server to low-risk servers. Subsequently operation either shifts back to obtaining more parameters (at operation 8-21) via path 8-27, or back to building a new model or updating the current model (starting from operation 8-10 again) via path 8-26.

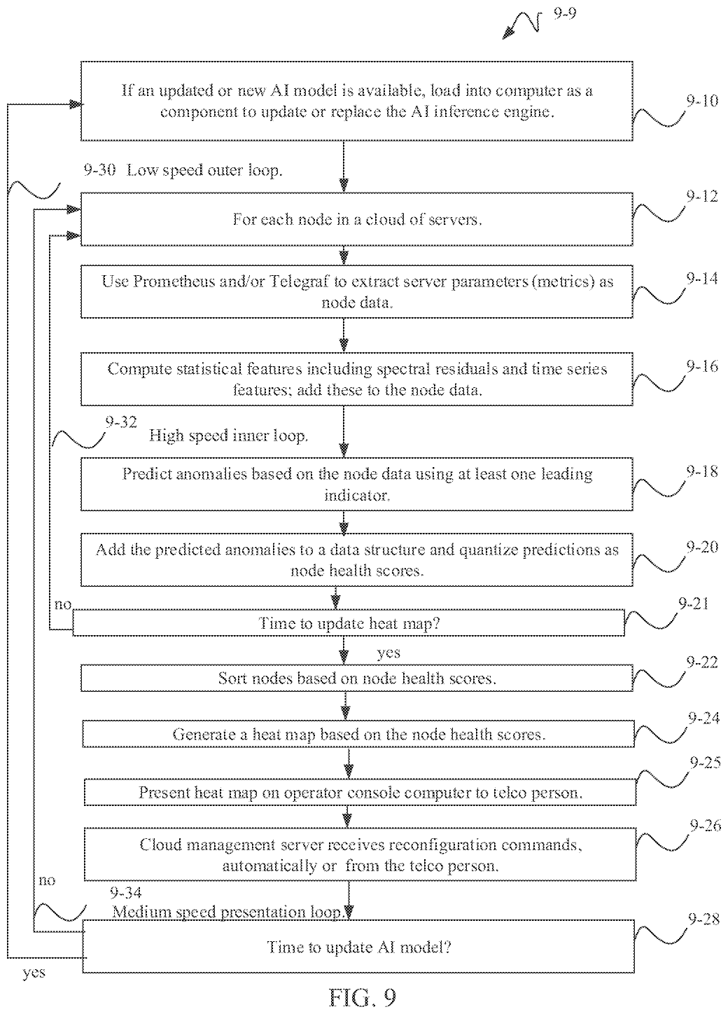

FIG. 9 illustrates exemplary logic 9-9 with further details for realization of the logic of FIGS. 7A, 7B and/or FIG. 8.

At operation 9-10, if a new or updated AI model becomes available, logic 9-9 loads the new or updated AI model as a component into computer 3-90. The trained AI model 1-11 and the computer 3-90 together form the AI inference engine 3-20.

At operation 9-12, logic 9-9 extracts (by, for example, using Prometheus and/or Telegraf API) approximately 500 server parameters (e.g., in the form of metrics) as node data. At operation 9-16, logic 9-9 computes statistical features including spectral residuals and time series features, and add these statistical features to the node data. At operation 9-18, logic 9-9 identifies anomalies based on the node data. This operation may be referred to as “predict anomalies.” The anomalies are the basis of server health scores. At operation 9-20, logic 9-9 adds the predicted anomalies to a data structure and quantizes predictions as node health scores. At operation 9-21, if there are more nodes to analyze, logic 9-9 follows path 9-32 to return to operation 9-12 and repeats the subsequent operations for the next node. In some embodiments, updates to the heat map are associated with two processes. In a first process, health scores for each server of the servers 1-4 are obtained. In a second process, a list of at-risk servers is maintained, and a heat map for the at-risk servers is obtained every ten minutes. There may be, in this example, six heat maps 3-41 per hour. In this example, there is an at-risk heat map and a system-wide heat map. The at-risk heat map and the system-wide heat map may be presented, for example side-by-side on a display screen for observation by telco person 3-40. The display screen may large, for example, covering a wall of an operations center. Alternatively, telco person 3-40 may select whether they wish to view the heat map for the entire system or the heat map only for the at-risk servers at any given moment.

At operation 9-22, logic 9-9 sorts nodes based on node health scores. At operation 9-24, logic 9-9 generates a heat map based on the node health scores, and presents it on operator console computer to the telco person at operation 9-25. At operation 9-26, the cloud management server receives reconfiguration commands from the telco person or automatically from the AI inference engine. Whether the cloud management server should receive reconfiguration commands from the telco person or should receive reconfiguration commands from the AI Inference engine may be based on how mature the model is, how accurate the model is, how long the model has been successfully in use.

At operation 9-28, logic 9-9 determines whether or not it is time to update AI model. If it is time for a new model or model update, logic 9-9 follows path 9-30, otherwise it follows path 9-34.

FIG. 10 illustrates an example decision tree 10-9 (only one tree of many) of the AI inference engine 3-20, according to some embodiments. The values f0, f1, f2, f4, f6, f7 are statistics (see Table 4 and FIG. 11). The statistics are compared with thresholds in the decision tree. The decision tree is completely specified by the trained AI model 1-11. The input to the decision tree is based on the most-recently collected server parameters. The leaves of the decision tree are the classifications and probabilities for the server that the server parameters come from. Acting on the input, a leaf is found for each decision tree by passing from the root to a leaf, with the path through the decision tree determined by the results of the threshold comparisons. The health score is based on a linear combination over the decision trees. The number of the decision trees is determined by the model builder computer 3-10, using, for example, supervised learning (via xgboost or the like).

The root of the example decision tree in FIG. 10 is indicated as 10-1 and compares a statistic value f0 with a threshold. Depending on the comparison, the logic of the decision tree flows via 10-2 (“yes, or missing”) to node 10-4. “Yes” means f0 is less than the threshold. “Missing” means that f0 was not available. Alternatively to the path 10-2, the logic flows via 10-3 to node 10-5. Flow then continues through the tree, ending at a leaf.

An example leaf 10-6 is shown connected to node 10-4. The leaf represents a classification category and a probability. The probability in FIG. 10 is given as a log-odds probability.

FIG. 11 illustrates an example decision tree 11-9 (one of many decision trees) of the AI inference engine 3-20 including probability measures, according to some embodiments.

Each leaf indicates a probability. The probability is a conditional probability that is based on the path traversed from the root of the tree to a given leaf node. For example, consider a leaf node. The probability that the observation is a 1 can be mathematically defined as follows, for an example: Probability(is_anomaly=1|processes_blocked>10 & system_load_rolling_z_score>45). These expressions represent the probabilities that the observation is an anomaly given that the number of processes_blocked>10 and the system_load_rolling_z_score>45. Thus, in practice, each decision tree is viewed as an extensive display of conditional probabilities.

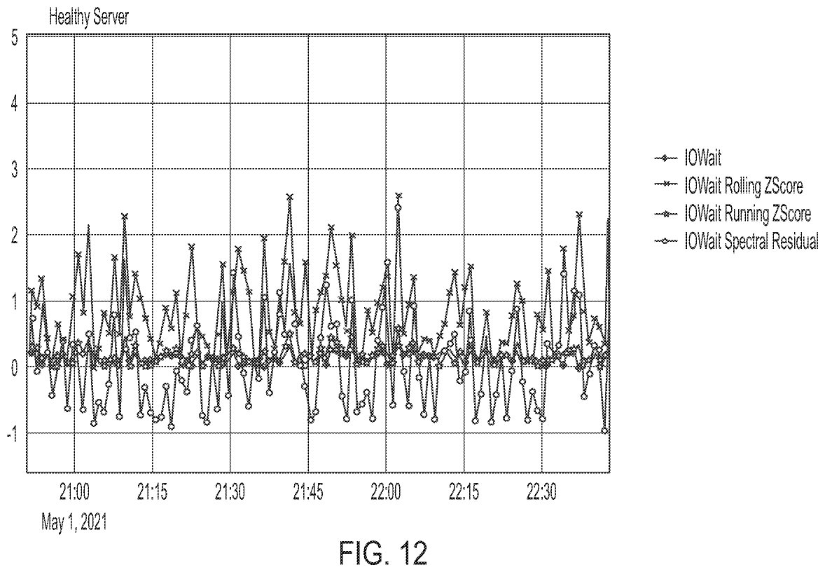

FIG. 12 illustrates, for a healthy server, exemplary time series data of different statistics types applied to server parameters 3-50, according to some embodiments. Also see Table 1 for exemplary healthy server data. This is actual data from an operational cloud of servers 1-5 and indicates that the server being considered is not at-risk (that is, the server is a low-risk server).

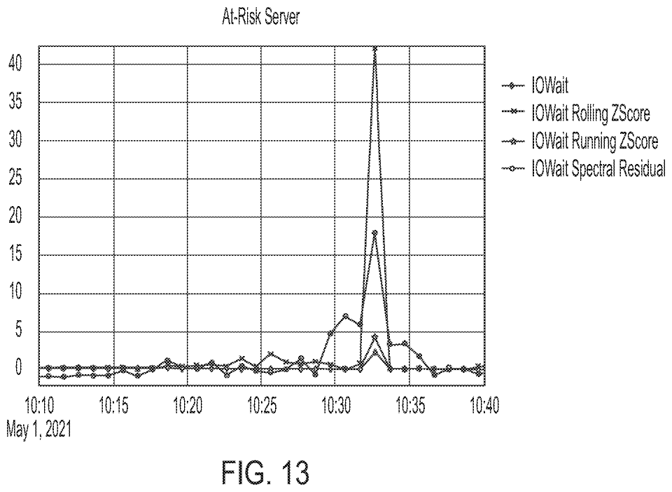

FIG. 13 illustrates, for at-risk server 1-8, exemplary time series data of different statistics types applied to server parameters 3-50, according to some embodiments. Also see Table 2 for exemplary at-risk server data. The data is from an operational server cloud. The peak of the IOWait Rolling ZScore at a time of approximately 10:32 indicates the sever is at-risk. This server is an actual server and did eventually fail. By using the logic of FIGS. 7A, 7B, 8 and/or 9, the at-risk server can be predicted as at-risk before failure, and virtual machines supporting services used by UEs 4-11 can be shifted to low-risk servers from the at-risk server without loss or delay of data to the UEs 4-11. This improves performance of the system 4-9.

Applicants have recognized that a fragile server exhibits symptoms under stress before it fails. For example, traffic patterns may be bursty. As a simplified discussion to explain, the following example is provided. Under a bursty traffic pattern a system may produce a statistic value of 0.98 S_{F} while reaching a value of S_{F} is historically associated with failure. That is, when the server is almost broken some other future traffic will be even higher imposing more stress on some servers of the cloud of servers 1-5 sending the statistic to a value at or above S_{F} in this simplified example. Recognizing this, Applicants provide a solution that takes action ahead of time (e.g., by weeks or hours) depending on system condition and traffic pattern that occurs. Network operators are aware of traffic patterns and Applicants include in the solution considering the nature of a server weakness and immediate traffic expected in determining on when to shift load away from an at-risk (fragile) server.

For example, at a next site change management cycle, action may be taken. It is normal to periodically bring a system down (planned downtime, when and as required). This may also be referred to as a maintenance window. When a server is identified that needs attention, embodiments provide that the server load is shifted. The shift can depend on a maintenance window. If a maintenance window is not within forecast of predicted failure, the load is shifted (for example, a virtual machine (VM) running on the at-risk server) promptly without causing user down time. The load may be shifted with involvement of telco person 3-40 (called “human in the loop” by one of the skill in the art) or automatically shifted by the AI inference engine.

Some examples determined from study of the problem and solution are now given. The inference machine predicts potential failure from X time to Y time (2 hours to 1 week) before actual failure. It depends on the failure type. For example, certain hardware failures can be predicted roughly a week in advance, whereas other failures can be predicted within an hour's notice.

A hot-swap (for example, shift of a VM from an at-risk server to a low-risk server) can be completed in a matter of T1 to T2 minutes (5 to 10 minutes, for example), so the failure prediction is useful if the anomaly is detected at T3 (for example, approximately 30 minutes) ahead of an actual failure. Some hot-swapping takes on the order of 5-10 minutes but many hot swaps can be performed in about 2 minutes. Thus, the failure prediction of the embodiments is useful in real time because the anomaly is captured in enough time for: (1) the network operator to be aware of the anomaly, (2) the network operator to take action.

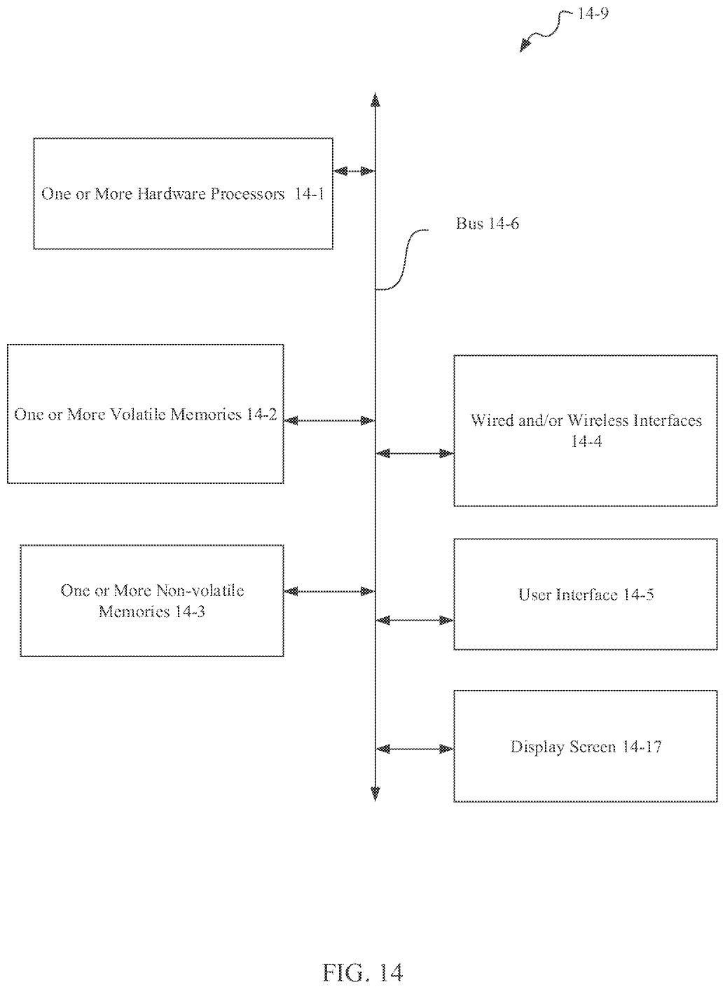

FIG. 14 illustrates an exemplary hardware and software configuration of any of the apparatuses described herein. One or more of the processing entities of FIG. 3A (such as the model builder computer 3-10, the AI inference engine 3-20 which includes computer 3-90, the operating console computer 3-30) may be implemented using hardware and software similar to that shown in FIG. 14. FIG. 14 illustrates a bus 14-6 connecting one or more hardware processors 14-1, one or more volatile memories 14-2, one or more non-volatile memories 14-3, wired and/or wireless interfaces 14-4 and user interface 14-5 (display screen, mouse, touch screen, keyboard, etc.). The non-volatile memories 14-3 may include a non-transitory computer readable medium storing instructions for execution on the one or more hardware processors.

Further notes are now provided in three sections discussing general aspects related to FIG. 3A.

### Model Builder Computer 3-10 of FIG. 3A

Note 1. A method of building an artificial intelligence (AI) model using big data (see previously described Table 3 and flow 3-13), the method comprising: forming a matrix of data time series and statistic types (see previously described Table 4), wherein each row of the matrix corresponds to a time series of a different server parameter of one or more server parameters and each column of the matrix corresponds to a different statistic type of one or more statistic types; determining a first content of the matrix at a first time; determining a second content of the matrix at a second time; determining at least one leading indicator by processing at least the first content and the second content; building a plurality of decision trees based on the at least one leading indicator; and outputting the plurality of decision trees as the trained AI model.

Note 2. The method of note 1, wherein the one or more statistic types includes one or more of a first moving average of the server parameter, a first entire average of the server parameter, a z-score of the server parameter, a second moving average of standard deviation of the server parameter, a second entire average of standard deviation of the server parameter, or a spectral residual of the server parameter.

Note 3. The method of note 1, wherein the server parameter includes a field programmable gate array (FPGA) parameter, a CPU parameter, a memory parameter, and/or an interrupt parameter.

Note 4. The method of note 3, wherein the FPGA parameter is airflow and/or message queue, the CPU parameter is load and/or processes, the memory parameter is IRQ or DISKIO, and the interrupt parameter is IPMI and/or IOWAIT.

Note 5. The method of note 1, wherein each decision tree of the plurality of decision trees includes a plurality of decision nodes, a corresponding plurality of decision thresholds are associated with the plurality of decision nodes, and the building the plurality of decision trees comprises choosing the plurality of decision thresholds to detect anomaly patterns of the at least one leading indicator over a first time interval.

Note 6. The method of note 5, wherein the big data comprises a plurality of server diagnostic files associated with a first server of a plurality of servers, a dimension of the plurality of server diagnostic files indicating that there is a first number of files in the plurality of server diagnostic files, and the first number is more than 1,000.

Note 7. The method of note 6, wherein the first time interval is about one month.

Note 8. The method of note 7, wherein a most recent version of a first file of the plurality of server diagnostic files associated with the first server is obtained about every 1 minute, 10 minutes or 60 minutes.

Note 9. The method of note 8, wherein a second number of copies of the first file is on an order of an expression M, wherein M=1/minute*60 min/hour*24 hours/day*30 days per month*the first time interval=50,000, a dimension of the one or more server parameters is greater than 500.

Note 10. The method of note 9, wherein the plurality of decision trees are configured to process the second number of copies of the first file to make a prediction of hardware failure related to the first node.

Note 11. The method of note 10, wherein a second dimension of the plurality of servers indicating that there is a second number of servers in the plurality of servers, and the second number of servers is greater than 1,000.

Note 12. The method of note 11, wherein the plurality of decision trees are configured to implement a light-weight process, and the plurality of decision trees are configured to output a health score for each server of the plurality of servers, and the plurality of decision trees being scalable with respect to the second number of servers, wherein scalable includes a linear increase in the number of servers causing only a linear increase in the complexity of the plurality of decision trees.

Note 13. A model builder computer comprising: one or more processors (see 14-1 of FIG. 14); and one or more memories (see 14-2 and 14-3 of FIG. 14), the one or more memories storing a computer program (see FIGS. 5, 7A, 7B, 8 and 9), the computer program including: interface code configured to obtain server log data, and calculation code configured to: determine at least one leading indicator, and build a plurality of decision trees based on the at least one leading indicator, wherein the interface code is further configured to send the plurality of decision trees, as the trained AI model, to a computer thereby forming an AI inference engine.

Note 14. An AI inference engine (see 3-20 of FIG. 3A) comprising: one or more processors (see 14-1 of FIG. 14); and one or more memories (see 14-2 and 14-3 of FIG. 14), the one or more memories storing a computer program (see FIGS. 5, 7A, 7B, 8 and 9), the computer program including: interface code configured to: receive a trained AI model, and receive a flow of server parameters from a cloud of servers, and calculation code configured to: determine at least one leading indicator for each server of the cloud of servers, wherein the at least one leading indicator is based on the flow of server parameters; determine, based on the at least one leading indicator and a plurality of decision trees corresponding to the trained AI model, a plurality of health scores corresponding to servers of the cloud of servers, wherein the interface code is further configured to output the plurality of health scores to an operating console computer.

Note 15. An operating console computer (see 3-30 of FIG. 3A) comprising: a display, a user interface, one or more processors (see 14-1 of FIG. 14); and one or more memories (see 14-2 and 14-3 of FIG. 14), the one or more memories storing a computer program (see FIGS. 5, 7A, 7B, 8 and 9), the computer program including: interface code configured to receive a plurality of health scores, and user interface code configured to: present, on the display, at least a portion of the plurality of health scores to a telco person, and receive input from the telco person, wherein the interface code is further configured to communicate with a cloud management server to cause, based on the plurality of health scores, a shift of a virtual machine (VM) from an at-risk server to a low-risk server.

Note 16. A system comprising: the inference engine of note 14 which is configured to receive a flow of server parameters (see 3-13 of FIG. 3A) from a cloud of servers (see 1-5 of FIG. 1), the operating console computer of note 15, and the cloud of servers.

Note 17. A system comprising: the model builder computer of note 13; the inference engine of note 14 which is configured to receive a flow of server parameters from a cloud of servers; the operating console computer of note 15; and the cloud of servers.

### AI Inference Engine Configured to Predict Hardware Failures (the Numbering of Notes Re-Starts from 1)

Note 1. An AI inference engine (see 3-20 of FIG. 3A) configured to predict hardware failures, the AI inference engine comprising: one or more processors (see 14-1 of FIG. 14); and one or more memories (see 14-2 and 14-3 of FIG. 14), the one or more memories storing a computer program (see FIGS. 5, 7A, 7B, 8 and 9) to be executed by the one or more processors, the computer program comprising: configuration code configured to cause the one or more processors to load the trained AI model into the one or more memories; server analysis code configured to cause the one or more processors to: obtain at least one server parameter in a first file for a first node in a cloud of servers, wherein the at least one server parameter includes at least one leading indicator, compute at least one leading indicator as a statistical feature of the at least one server parameter for the first node, detect at least one anomaly of the first node, reduce the at least one anomaly to a health score, and add an indicator of the at least one anomaly and the health score to a data structure; control code configured to cause the one or more processors to repeat an execution of the server analysis code for N-1 nodes other than the first node, N is a first integer, thereby obtaining a first plurality of the at least one server parameter and forming a plurality of health scores, wherein N is greater than 1000; and presentation code configured to cause the one or more processors to: formulate the plurality of health scores into a visual page presentation, and send the visual page presentation to a display device for observation by a telco person.

Note 2. The AI inference engine of note 1, wherein the first plurality of the at least one server parameter comprises big data, the big data comprises a plurality of server diagnostic files (see FIG. 3C), a first dimension of the plurality of server diagnostic files is M, M is a second integer, and M is more than 1,000.

Note 3. The AI inference engine of note 1, wherein the at least one server parameter includes a field programmable gate array (FPGA) parameter, an airflow parameter, a CPU parameter, a memory parameter, and/or an interrupt parameter.

Note 4. The AI inference engine of note 3, wherein the FPGA parameter is message queue, the CPU parameter is load and/or processes, the memory parameter is IRQ or DISKIO, and the interrupt parameter is IPMI and/or IOWAIT (see FIG. 3A, annotation of 1-8).

Note 5. The AI inference engine of note 4, wherein the trained AI model represents a plurality of decision trees, wherein a first decision tree of the plurality of decision trees includes a plurality of decision nodes, a corresponding plurality of decision thresholds are associated with the plurality of decision nodes (see FIG. 10), and the trained AI model is configured to cause the plurality of decision trees to detect anomaly patterns of the at least one leading indicator over a first time interval (see FIG. 13).

Note 6. The AI inference engine of note 5, wherein the first time interval is about one week or one month.

Note 7. The AI inference engine of note 6, wherein the control code is further configured to update the first plurality of the at least one server parameter about once every 1 minute, 10 minutes or 60 minutes.

Note 8. The AI inference engine of note 7, wherein the AI inference engine is configured to predict the health score of the first node based on a number of copies of the first file, wherein the number of copies of the first file is on an order of an expression M, wherein M=1/minute*60 min/hour*24 hours/day*30 days per month*the first time interval=50,000, a second dimension of the at least one server parameter is greater than 500.

Note 9. The AI inference engine of note 3, wherein the at least one server parameter includes a data parameter, and the at least one statistical feature includes one or more of a first moving average of the data parameter, a first entire average over all past time of the data parameter, a z-score of the data parameter, a second moving average of standard deviation of the data parameter, a second entire average of signal of the data parameter, and/or a spectral residual of the data parameter (see Table 4 previously described).

Note 10. A method for performing inference to predict hardware failures, the method comprising: loading a trained AI model into the one or more memories; obtaining at least one server parameter in a first file for a first node in a cloud of servers; computing at least one leading indicator as a statistical feature of the at least one server parameter for the first node; detecting zero or more anomalies of the first node; quantizing a result of the detecting to a health score; adding an indicator of the anomalies and the health score to a data structure; repeating the steps of the obtaining, the computing, the detecting, the reducing and the adding for N-1 nodes other than the first node, N is a first integer, thereby obtaining a first plurality of the at least one server parameter and forming a plurality of health scores, wherein N is greater than 1000; formulating the plurality of health scores into a visual page presentation; and sending the visual page presentation to a display device for observation by a telco person (see FIGS. 3A, 7A, 7B, 8, and 9).

### Heat Map Interface Apparatus for Interaction with Telco Maintenance Operator (the Numbering of Notes Re-Starts from 1)

Note 1. A system comprising: an operating console computer including a display device, a user interface, and a network interface; and an AI inference engine (see FIG. 3A) comprising: one or more processors; and one or more memories, the one or more memories storing a computer program, the computer program including: interface code configured to: receive a trained AI model, and receive a flow of server parameters from a cloud of servers; calculation code configured to: determine at least one leading indicator for each server of a cloud of servers, wherein the at least one leading indicator is based on the flow of server parameters, and determine, based a plurality of decision trees (see FIG. 10) corresponding to the trained AI model, a plurality of health scores corresponding to servers of the cloud of servers, wherein the interface code is further configured to output the plurality of health scores to an operating console computer, wherein the operating console computer is configured to: display the visual page presentation on the display device, receive on the user interface responsive to the visual page presentation on the display device, a command (possibly from the telco person) (see FIG. 3A), and send, via the network interface, a request to a cloud management server, wherein the request identifies the first node, and the request indicates that virtual machines associated with a telco of the telco person are to be shifted from the first node to another node (see FIG. 4C).

Note 2. A system comprising: an operating console computer (see 3-30 of FIG. 3A) including a display screen (see 14-7 of FIG. 14), a user interface (see 14-5 of FIG. 14, which may be included in the display screen), and a first network interface (see 14-4 of FIG. 14); and an inference engine (see 3-20) comprising: a second network interface (see 14-4 of FIG. 14); one or more processors; and one or more memories, the one or more memories storing a computer program to be executed by the one or more processors, the computer program comprising: prediction code configured to cause the one or more processors to form a data structure comprising anomaly predictions and health scores for a first plurality of nodes; sorting code configured to cause the one or more processors to sort the first plurality of nodes based on the health scores; generating code configured to cause the one or more processors to generate a heat map based on the sorted plurality of nodes; presentation code configured to cause the one or more processors to: formulate the heat map into a visual page presentation, wherein the heat map includes a corresponding health score for each node of the first plurality of nodes, and send the visual page presentation to the display device for observation by a telco person.

Note 3. The system of note 2, wherein the heat map is configured to indicate a first trend based on a first plurality of predicted node failures of a corresponding first plurality of nodes, wherein the first trend is correlated with a first geographic location within a first distance of each geographic location of each node of the first plurality of nodes.

Note 4. The system of note 2, wherein the heat map is configured to indicate a second trend based on a second plurality of predicted node failures of a second plurality of nodes, wherein the second trend is correlated with a same protocol in use by each node of the second plurality of nodes.

Note 5. The system of note 4, wherein the heat map is configured to indicate a third trend based on a third plurality of predicted node failures of a third plurality of nodes, wherein the third trend is correlated with both: i) a same protocol in use by each node of the second plurality of nodes and ii) a geographic location within a third distance of each geographic location of each node of the third plurality of nodes.

Note 6. The system of note 4, wherein the heat map is configured to indicate a spatial trend based on a third plurality of predicted node failures of a third plurality of nodes, and the heat map is further configured to indicate a temporal trend based on a fourth plurality of predicted node failures of a fourth plurality of nodes.

Note 7. The system of note 2, wherein the operating console computer is configured to: receive, responsive to the visual page presentation and via the user input device, a command from the telco person; and send a request to a cloud management server, wherein the request identifies a first node, and the request indicates that virtual machines associated with a telco of the telco person are to be shifted from the first node to another node.

Note 8. The system of note 2, wherein the operating console computer is configured to provide additional information about a second node when the telco person uses the user input device to indicate the second node.

Note 9. The system of note 8, wherein the additional information is configured to indicate a type of the anomaly, an uncertainty associated with a second health score of the second node, and/or a configuration of the second node (see FIG. 6).

Note 10. The system of note 9, wherein the type of the anomaly is associated with one or more of a field programmable gate array (FPGA) parameter, an airflow parameter, a CPU parameter, a memory parameter, and/or an interrupt parameter.

Note 11. The system of note 10, wherein the FPGA parameter is message queue, the CPU parameter is load and/or processes, the memory parameter is IRQ or DISKIO, and the interrupt parameter is IPMI and/or IOWAIT (see annotation on 1-8 of FIG. 3A).

Note 12. The system of note 2, wherein the network interface code is further configured to cause the one or more processors to form the data structure about once every 1 minute, 10 minutes or 60 minutes.

Note 13. The system of note 12, wherein the presentation code is further configured to cause the one or more processors to update the heat map once every 10 minutes to 60 minutes.

Note 14. The system of note 2, wherein the anomaly predictions are based on at least one leading indicator based on a statistical feature of at least one server parameter, the at least one server parameter including a field programmable gate array (FPGA) parameter, an airflow parameter, a CPU parameter, a memory parameter, and/or an interrupt parameter.

Note 15. The system of note 14, wherein the statistical feature includes one or more of a first moving average of the server parameter, a first entire average of the server parameter, a z-score of the server parameter, a second moving average of standard deviation of the server parameter, a second entire average of standard deviation of the server parameter, or a spectral residual of the server parameter (see Table 4, previously described).

1. A system comprising:
an operating console computer including a display device, a user interface, and a first network interface; and
an inference apparatus comprising:
a second network interface;
one or more processors; and
one or more memories, the one or more memories storing a computer program to be executed by the one or more processors, the computer program comprising:
prediction code configured to cause the one or more processors to form a data structure comprising anomaly predictions and health scores for a first plurality of nodes,
sorting code configured to cause the one or more processors to sort the first plurality of nodes based on the health scores,
generating code configured to cause the one or more processors to generate a heat map based on the sorted plurality of nodes,
presentation code configured to cause the one or more processors to:
formulate the heat map into a visual page presentation, wherein the heat map includes a corresponding health score for each node of the first plurality of nodes, and
send the visual page presentation to the display device for observation by a telco person.

2. The system of claim 1, wherein the heat map is configured to indicate a first trend based on a first plurality of predicted node failures of a corresponding first plurality of nodes, wherein the first trend is correlated with a first geographic location within a first distance of each geographic location of each node of the first plurality of nodes.

3. The system of claim 1, wherein the heat map is configured to indicate a second trend based on a second plurality of predicted node failures of a second plurality of nodes, wherein the second trend is correlated with a same protocol in use by each node of the second plurality of nodes.

4. The system of claim 1, wherein the heat map is configured to indicate a third trend based on a third plurality of predicted node failures of a third plurality of nodes, wherein the third trend is correlated with both: i) a same protocol in use by each node of the third plurality of nodes and ii) a geographic location within a third distance of each geographic location of each node of the third plurality of nodes.

5. The system of claim 2, wherein the heat map is configured to indicate a spatial trend based on a third plurality of predicted node failures of a third plurality of nodes, and the heat map is further configured to indicate a temporal trend based on a fourth plurality of predicted node failures of a fourth plurality of nodes.

6. The system of claim 1, wherein the operating console computer is configured to:
receive, responsive to the visual page presentation and via a user input device, a command from the telco person; and
send a request to a cloud management server, wherein the request identifies a first node, and the request indicates that virtual machines associated with a telco of the telco person are to be shifted from the first node to another server.

7. The system of claim 1, wherein the operating console computer is configured to provide additional information about a second node when the telco person uses a user input device to indicate the second node.

8. The system of claim 7, wherein the additional information is configured to indicate a type of the anomaly, an uncertainty associated with a second health score of the second node, and/or a configuration of the second node.

9. The system of claim 8, wherein a type of the anomaly is associated with one or more of a field programmable gate array (FPGA) parameter, an airflow parameter, a CPU parameter, a memory parameter, and/or an interrupt parameter.

10. The system of claim 9, wherein the FPGA parameter is message queue, the CPU parameter is load and/or processes, the memory parameter is IRQ or DISKIO, and the interrupt parameter is IPMI and/or IOWAIT.

11. The system of claim 1, wherein the prediction code is further configured to cause the one or more processors to form the data structure about once every 10 minutes.

12. The system of claim 11, wherein the presentation code is further configured to cause the one or more processors to update the heat map once every 1 to 60 minutes.

13. The system of claim 1, wherein the anomaly predictions are based on at least one leading indicator based as a statistical feature of at least one server parameter, the at least one server parameter including a field programmable gate array (FPGA) parameter, an airflow parameter, a CPU parameter, a memory parameter, and/or an interrupt parameter.

14. The system of claim 13, wherein the statistical feature includes one or more of a first moving average of a first server parameter, a first entire average of the first server parameter, a z-score of the first server parameter, a second moving average of standard deviation of the first server parameter, a second entire average of standard deviation of the first server parameter, or a spectral residual of the first server parameter.

15. An operating console computer comprising:
a display,
a user interface,
one or more processors; and
one or more memories,
the one or more memories storing a computer program, the computer program including:
interface code configured to receive a plurality of health scores, and
user interface code configured to:
present, on the display, at least a portion of the plurality of health scores to a telco person, and
receive input from the telco person,
wherein the interface code is further configured to communicate with a cloud management server to cause, based on the plurality of health scores, a shift of a virtual machine (VM) from an at-risk server to a low-risk server.

16. A method comprising:
forming a data structure comprising anomaly predictions and health scores for a first plurality of nodes,
sorting the first plurality of nodes based on the health scores,
generating a heat map based on the sorted plurality of nodes,
formulating the heat map into a visual page presentation, wherein the heat map includes a corresponding health score for each node of the first plurality of nodes, and
sending the visual page presentation to a display device for observation by a telco person.

17. The method of claim 16, wherein the heat map is configured to indicate a first trend based on a first plurality of predicted node failures of a corresponding first plurality of nodes, wherein the first trend is correlated with a first geographic location within a first distance of each geographic location of each node of the first plurality of nodes.

18. The method of claim 16, further comprising:
receiving, responsive to the visual page presentation and via a user input device, a command from the telco person; and
sending a request to a cloud management server, wherein the request identifies a first node, and the request indicates that virtual machines associated with a telco of the telco person are to be shifted from the first node to another server.

19. The method of claim 16, wherein the statistical feature includes one or more of a first moving average of a first server parameter, a first entire average of the first server parameter, a z-score of the first server parameter, a second moving average of standard deviation of the first server parameter, a second entire average of standard deviation of the first server parameter, or a spectral residual of the first server parameter.

20. A non-transitory computer readable medium storing a computer program for execution by a computer, the computer including one or more processors, the computer program comprising:
interface code configured to receive a plurality of health scores, and
user interface code configured to:
present, on a display, at least a portion of the plurality of health scores to a telco person, and
receive input from the telco person,
wherein the interface code is further configured to communicate with a cloud management server to cause, based on the plurality of health scores, a shift of a virtual machine (VM) from an at-risk server to a low-risk server.
